(19) United States
(12) Patent Application Publication
(10) Pub. No.: US 2002/0002513 A1
(43) Pub. Date: Jan. 3, 2002

(54) COMPUTER NETWORK TRANSACTION SYSTEM

(76) Inventor: JAMES P. CHIASSON, BURLINGTON, VT (US)

Correspondence Address: DOWNS RACHLIN & MARTIN, 199 MAIN STREET, P O BOX 190, BURLINGTON, VT, 054020190

(21) Appl. No.: 09/220,666

(22) Filed: Dec. 24, 1998

Related U.S. Application Data
(60) Provisional application No. 60/109,833, filed on Nov. 25, 1998.

(51) Int. Cl. G06F 17/60

(52) U.S. Cl. 705/27

(57) ABSTRACT

A system (20) for conducting interactive electronic commerce, including shopping, bill payment and investment portfolio activities, across a network, such as the Internet, among multiple merchant sites (24), multiple billing sites (25) or multiple investment sites (26). The system includes tools that facilitate such activities, which tools are displayed as frames in a portion of the display of a user's computer. Remaining portions of the display of a user's computer may be filled with content from a merchant site, payment site, investment site or other site of interest. Information may be readily transferred from, for example, the web page of a merchant site to an e-catalog (124) where information concerning an item of interest is stored. Templates (122) are provided for facilitating entry of such information. An order may be submitted to multiple merchant sites based on the contents of the e-catalog as a single operation. Similarly, bills may be paid to multiple billing sites as a single operation and investment transactions may be effected with multiple investment sites as a single operation.

This application claims the benefit of U.S. Provisional Application No. 60/109,833, filed Nov. 25, 1998.

### FIELD OF THE INVENTION

The present invention pertains to a system for conducting interactive electronic commerce, including shopping, bill payment, and investment portfolio activities, across a network, such as the Internet, among multiple merchant electronic commerce sites, multiple bill payment sites and multiple investment sites and, more particularly, to such a system that permits transactions with a plurality of such sites to be performed as a single operation.

### BACKGROUND OF THE INVENTION

With the explosive commercial growth of the Internet in recent years, systems have been developed to support on-line electronic shopping, otherwise known as electronic commerce or e-commerce. An e-commerce merchant site is accessed by a potential customer using a browser such as the NAVIGATOR® browser of Netscape Communications Corporation or the EXPLORER® browser of Microsoft Corporation. With the browser, the customer enters the uniform resource locator (URL) for the e-commerce merchant site, or searches for the e-commerce merchant site using a search engine such as those identified by the marks EXCITE® of Excite Inc., YAHOO® of Yahoo! Inc., or LYCOS® of Lycos, Inc., and appropriate word queries. Once a desired e-commerce merchant site is located, e-commerce proceeds between the customer and such site.

To support e-commerce, merchant sites use e-commerce application programs of the type described in U.S. Pat. Nos. 5,715,314 and 5,745,681, which operate on standard servers. Existing e-commerce application programs support e-commerce between a given customer and a given merchant site in a reasonably effective manner. Unfortunately, it tends to be inefficient and time consuming for a given customer to shop and order products from multiple e-commerce merchant sites. First, e-commerce merchant sites must be sequentially accessed by entry of the appropriate URL, by hypertext linking (if available to the desired merchant site) or by searching the World Wide Web (the web) with a suitable search engine.

If the customer wants to comparison shop by price, size, color and the like, it is necessary for the customer to independently record product information, e.g., print web pages, or write down information on a pad of paper, and then return to the merchant site offering the selected item to place an order. Next, the customer must complete a specified set of profile information to complete an order, e.g., name, shipping address, credit card number for each merchant, which takes time and can be frustrating. This process must then be repeated for each merchant site from which the customer wants to purchase a product. As a consequence, customers often shop at only a limited number of e-commerce merchant sites.

E-commerce has also been made somewhat easier recently by search engines and other electronic forums which contain hypertext links to multiple merchant sites in a single web page, sometimes known as electronic malls or virtual malls. Electronic malls may simplify locating merchant sites of interest, but they do not overcome the requirement to create separate customer profiles for each merchant site, place separate orders with each merchant site, and independently record comparison shopping information within or across merchant sites. Furthermore, known electronic malls typically only facilitate the sale of hard goods, not services and items that may be downloaded in digital form, e.g., software, business articles, music and medical research.

With the advent of Internet-based electronic banking, users can now authorize payment of certain bills electronically by specifying the payment type, payment source (e.g., credit card number or bank wire transfer number) and receiving entity. Also, users can enter a standing request with a bank or other financial institution to process a debit (e.g., a car loan) to a given source (e.g., a car loan) on a monthly or other regular basis. Furthermore, financial management software programs such as the one licensed by Intuit of Menlo Park, Calif., and identified by the trademark QUICKEN, permit users to pay bills to multiple entities electronically.

Various companies such as E-Trade Securities, Inc. of Palo Alto, Calif. (www.etrade.com) permit users to buy and sell stocks, options and other investment vehicles on-line via the Internet. It is typically difficult for a user to record in his or her computer information available via the Internet regarding investment opportunities at the same time such information is being displayed on the display of the user's computer. Furthermore, it tends to be difficult with known Internet investment sites for the user to buy or sell in a single operation investment vehicles from more than one investment site or bank.

Unfortunately, it tends to be difficult for a user to submit payment for bills to multiple entities as a single transaction via the Internet with known electronic banking and commerce systems. In addition, known systems do not tend to provide users with the flexibility and functionality they desire in receiving, processing and paying bills electronically.

### SUMMARY OF THE INVENTION

One aspect of the present invention is a transaction service system in a service computer for supporting e-commerce across a distributed computer network including a user computer having a display and browser for navigating the network, and a plurality of merchant sites each having a unique URL and an e-commerce system for enabling sale or other transfer of items, which e-commerce system may be accessed via the network with the browser of the user computer. The transaction service system comprises an item template module that provides an item template, permits a user to enter in the item template information available at a merchant site regarding an item offered by the merchant site, and provides for viewing on a first portion of the display of the user's computer at least one of the item templates. In addition, the transaction service system includes an e-catalog module that permits a user to assemble an e-catalog containing information regarding items offered at more than one merchant site, and provides for viewing on a second portion of the display of the user's computer at least some of the information in the e-catalog. The first portion and the second portion are sized so that a third portion of the display of the user's computer is not occupied by the first portion and the second portion.

Another aspect of the present invention is an e-commerce system comprising a computer network, at least one user computer connectable with the network, with the at least one user computer having a display and a browser for navigating the network and a plurality of merchant computers connectable with the at least one user computer via said network. Each merchant computer is programmed to operate an e-commerce system for enabling e-commerce with the at least one user computer. The e-commerce system also includes a service computer connectable with the at least one user computer and the plurality of merchant computers via said network. The service computer is programmed to operate a shopping system that permits a user to order items in a single order from more than one of the merchant computers.

A further aspect of the present invention is a method of assisting a user having a user computer with a display and a browser in obtaining items offered at a plurality of merchant sites linked via a network that the user can navigate with the browser so as to access merchant sites. The method comprises, as a first step, providing a template to the user computer, via the network, in which a user may enter information regarding an item offered at a merchant site. The template is provided so that it may be viewed on the display of the user computer at the same time content from the merchant site may be viewed in the display of the user computer. The second step involves building a collection of the information regarding items offered at more than one merchant site and providing at least some of the information in the collection so that it may be viewed on the display of the user computer at the same time content from the merchant site may be viewed in the display of the user computer. As a third step, an order is created using the information in the collection for items from more than one merchant site and a request is transmitted to each merchant site for those items included in the order which each merchant site offers.

These and other aspects of the present invention are described in more detail below and are illustrated in the accompanying drawings.

### BRIEF DESCRIPTION OF THE DRAWINGS

FIG. 1 is a block diagram of a e-commerce computer network in accordance with the present invention;

FIG. 2 is a schematic diagram illustrating the user's computer and its display when operating using the transaction service system of the present invention, and its relationship to sources of information contained in the display;

FIG. 3 is a block diagram of the various modules in the application program of the transaction system of the present invention;

FIG. 4 is a diagram illustrating the operations performed by the transaction service system and the user computer at an initial stage of operation;

FIGS. 5a and 5b are diagrams illustrating the operations performed by the transaction system and the user computer following selection of the shopping service link;

FIG. 6 is a diagram illustrating the operations performed by the transaction system and the user computer following selection of the select item category link;

FIG. 7 is a diagram illustrating the operations performed by the transaction system and the user computer following selection of the create item category link;

FIG. 8 is a diagram illustrating the operations performed by the transaction system, the user computer and the merchant computer following selection of the find and enter new item link;

FIG. 9 is a schematic illustration of the process by which a user populates an e-catalog based on information contained at merchant e-commerce sites;

FIG. 10 is a diagram illustrating the operations performed by the transaction system and the user computer following selection of the find existing items link;

FIG. 11 is a diagram illustrating the operations performed by the transaction system and a user computer following selection of the edit item link;

FIG. 12 is a diagram illustrating the operations performed by the transaction system and the user computer following selection of the view multimedia object link;

FIG. 13 is a diagram illustrating the operations performed by the transaction system and the user computer following selection of the sort/exclude items link;

FIGS. 14a and 14b are diagrams of the operations performed by the transaction system, the user computer and the merchant site following selection of the select items and send order link;

FIG. 15a is a schematic illustration of how a user can use the transaction system to complete a transaction involving multiple items from multiple merchants sites based on the contents of the e-catalog as a single transaction;

FIG. 15b is a schematic illustration of how a user completes multiple transactions to multiple merchants sites as multiple operations by completing the transactions outside the transaction system;

FIG. 16 is a diagram illustrating the operations of the transaction system and the user computer following completion of the submission of each SOEM to the outgoing queue operation in FIG. 14a;

FIGS. 17a and 17b are diagrams illustrating the operations performed by the transaction system and the user computer following selection of the bill payment service link;

FIGS. 18a and 18b are diagrams illustrating the operations performed by the transaction system and the user computer following selection of the request investment portfolio service link;

FIG. 19 is a diagram illustrating the operations of the transaction system and the user computer following selection of the retrieve e-mail for user link; and

FIG. 20 is a diagram illustrating the operations of the transaction system and the user computer following selection of the edit profile/settings link.

### DETAILED DESCRIPTION OF THE INVENTION

A. Overview

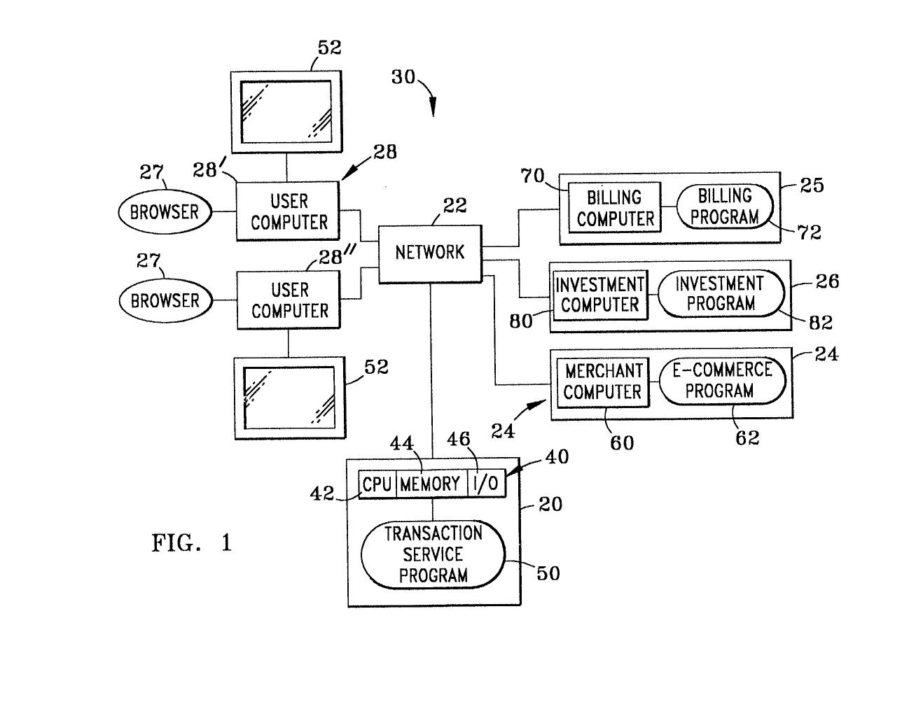

Referring to FIG. 1, as a brief overview, the present invention is transaction service system 20 (also referred to as “system 20”) for facilitating the purchase of goods and services, the acquisition of information, the payment of bills and the processing of investment portfolio transactions and other investment-related activities via e-commerce through a computer network 22, such as the Internet. While system 20 is preferably used with the Internet, network 22 may also comprise an Intranet, a local or wide area network, or a dial-in network. Network 22 may be wireless, linked by cable and optical fiber, or a combination thereof.

Goods and services are typically not offered for sale directly by transaction service system 20. Rather, system 20 is designed to aid a user in identifying, comparing and purchasing goods and services offered for sale by multiple e-commerce merchant sites 24 (only one of which is illustrated in FIG. 1). Bills may be paid using system 20 to multiple billing sites 25 (only one of which is illustrated in FIG. 1). Investment portfolio management, transactions and related activities may be conducted with multiple investment sites 26 (only one of which is illustrated in FIG. 1).

Assuming network 22 is the Internet, a user accesses transaction service system 20 using a browser 27 running on user computer 28, and then simultaneously accesses one of merchant sites 24, billing sites 25 or investment sites 26 using the browser. As described in detail below, transaction service system 20 provides a user with shopping, bill payment, and investment tools that appear together with information from a merchant site 24, billing site 25 or investment site 26 in the display of user computer 28.

The present invention provides various shopping service and related functions across the distributed computer network 30 made up of at least transaction service system 20, network 22, user computer 28, and one of merchant site 24, billing site 25 and investment site 26. These functions are implemented within the distributed computer network as a sequence of computer implemented steps and as interconnected machine modules. The specific implementation will depend upon the computer hardware and software used, performance requirements and other factors. Some variation in implementation may also be required as operating platforms change.

Transaction service system 20 includes a computer 40 having a central processing unit (CPU) 42, typically one or more microprocessors, memory 44, typically fast access, low capacity memory such as RAM, and slower access, high capacity memory such as optical and magnetic disk drives, and an input/output (I/O) section 46, typically including various communications adapters for communicating with network 22, a keyboard (not shown), a display (not shown) and other devices. Computer 40 will typically be a conventional server computer of the type used in client-server networks. Although described as a single computer, computer 40 may comprise several linked computers, in a single or multiple locations.

Transaction service system 20 also includes application program 50 stored in memory 44 of computer 40. As described in detail below, program 50 contains computing steps for achieving the shopping service, bill payment and investment management and transaction functions of the present invention. These steps are executed as logical operations by CPU 42 in combination with memory 44 and I/O section 46.

Describing the overall distributed computer network 30 in somewhat greater detail, browser 27 of user computer 28 is a conventional browser of the type used to navigate network 22. When network 22 is the Internet, suitable browsers are available from Microsoft Corporation, Redmond, Washington, under the trademark EXPLORER and from Netscape Communications Corporation, Mountain View, Calif., under the trademark NAVIGATOR. User computer 28 may be one of a wide variety of computing systems such as personal computers, set-top boxes, mobile telephones, personal digital assistants, other so-called “thin client” computing systems, interactive TV and other electronic devices and venues. Each user computer 28 includes a display 52 for displaying graphics and text. While only two user computers 28 are illustrated in FIG. 1, it is to be appreciated that distributed computer network 30 may contain millions, and some day even billions, of user computers. Individuals, businesses, governments, universities and other entities may all have user computers 28. The latter could be located in offices, cars, kiosks or be completely mobile.

E-commerce merchant sites 24 each include a merchant computer 60, typically one or more conventional server computers, and an e-commerce application program 62 for enabling e-commerce with user computers 28 across network 22. Exemplary e-commerce application programs that are usable as program 62 are described in U.S. Pat. No. 5,715,314 to Payne et al. and U.S. Pat. No. 5,745,681 to Levine et al., which patents are incorporated herein by reference. Program 62, as used herein, is considered to include multiple e-commerce programs and systems, such as electronic credit card verification systems, as well as related programs and systems, such as delivery service software systems. In this regard, each merchant site 24 must be able to manage customer information, execute on-line marketing programs like discount pricing, ensure secure and reliable order and financial transaction processes, and promptly and reliably ship, download (e.g., in the case of music or videos), or implement (e.g., in the case of a service) the transaction.

As used herein, including in the claims, “e-commerce” means any transaction that is initiated or otherwise effected by user computer 28 and involves communication via network 22 with other entities linked to the network such as merchant site 24, billing site 25 and investment portfolio site 26. E-commerce includes the purchase, sale, license and other transfer (including without charge) of goods, services, information of all types that may be provided in digital, printed or other form, and any other tangible or intangible item.

While only one merchant site 24 is illustrated in FIG. 1, it is to be appreciated that distributed computer network 30 may include millions of merchant sites. As used herein, a merchant site 24 means (a) an e-commerce merchant site that is Internet-based and has an Internet URL that is different from that of any other merchant site and (b) an e-commerce site that is based on a computer network other than the Internet and is accessed via a unique telephone number, in the case of a dial-up system, a unique file name in the case of a local or wide area network, or through other means of access specific to the e-commerce site.

Billing sites 25 in computer network 30 each include a billing computer 70 and a billing program 72 that is implemented by the billing computer for generating bills, receiving and processing bill payments and performing related functions. Billing site 25 may be the billing and payment computer system of any of a wide range of entities, e.g., a utility, a credit card company, an investment firm or a merchant site 24. As used herein, a billing site 25 means (a) a billing site that is Internet-based and has an Internet URL that is different from that of any other billing site and (b) a billing site that is not Internet-based and is accessed via a unique telephone number, in the case of a dial-up system, a unique file name in the case of a local or wide area network, or through other means of access specific to the billing site.

Investment sites 26 in computer network 30 each include an investment computer 80 and an investment program 82 that is implemented by the investment computer for receiving and processing investment transactions and related functions. Investment site 26 may be operated by a brokerage house, bank or other entity involved in the purchase and sale of stocks, bonds and other financial instruments. As used herein, an investment site 26 means (a) an investment site that is Internet-based and has an Internet URL that is different from that of any other investment site and (b) an investment site that is not Internet-based and is accessed via a unique telephone number, in the case of a dial-up system, a unique file name in the case of a local or wide area network, or through other means of access specific to the investment site.

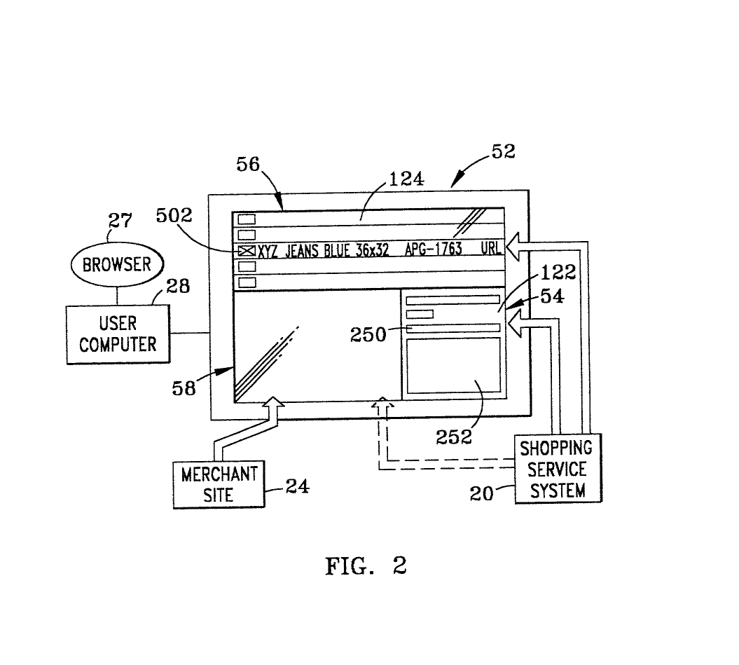

Turning now to FIGS. 1 and 2, as described in more detail below, a powerful feature of the transaction service system 20 is that multiple, preferably three, frames of information may be simultaneously presented in display 52 of user computer 28. The term “frame” as used herein does not necessarily mean a structure that extends around the entire periphery of display 52. Instead, “frame” means a portion of display 52. In a preferred embodiment, frame 54 appears along the right edge of display 52, frame 56 appears across the top of the display, and frame 58 occupies the remainder of the display. This permits a user to simultaneously view a page from, for example, a merchant site 24 in frame 58, while working with information and tools provided by transaction service system 20 in frames 52 and 54. As described in more detail below, system 20 provides dynamic operation such that at times the entire display 52 may be filed with a single frame, the system may provide information and tools in frame 58 and the size and relative placement of frames 54, 56 and 58 may be changed. Furthermore, with appropriate 3-D display graphics, frames 54, 56 and 58 may overlie one another such that content in “lower” frames may be viewed through content in “higher” frames.

When transaction service system 20 is implemented for use in an Internet environment, a user accesses the system just like any other site on the World Wide Web (hereinafter “web site”). Thus, the URL for system 20 (e.g., http://www.digishopper.com) is loaded via browser 27 and user computer 28 and using standard web-browsing protocols, e.g., HTML (HyperText Markup Language), HTTP (HyperText Transfer Protocol) and TCP/IP (Transmission Control Protocol/Internet Protocol) the home page for system 20 is located. In a preferred implementation for the Internet environment, user computer 28 functions as a client and system 20 functions as a server, with requests, selections and other operations merely being provided as inputs at user computer 28, with the operations actually being performed at system 20. Alternatively, system 20 may be implemented using the JAVA programming environment licensed by Sun Microsystems of Mountain View, Calif. or be implemented with other systems and in other environments.

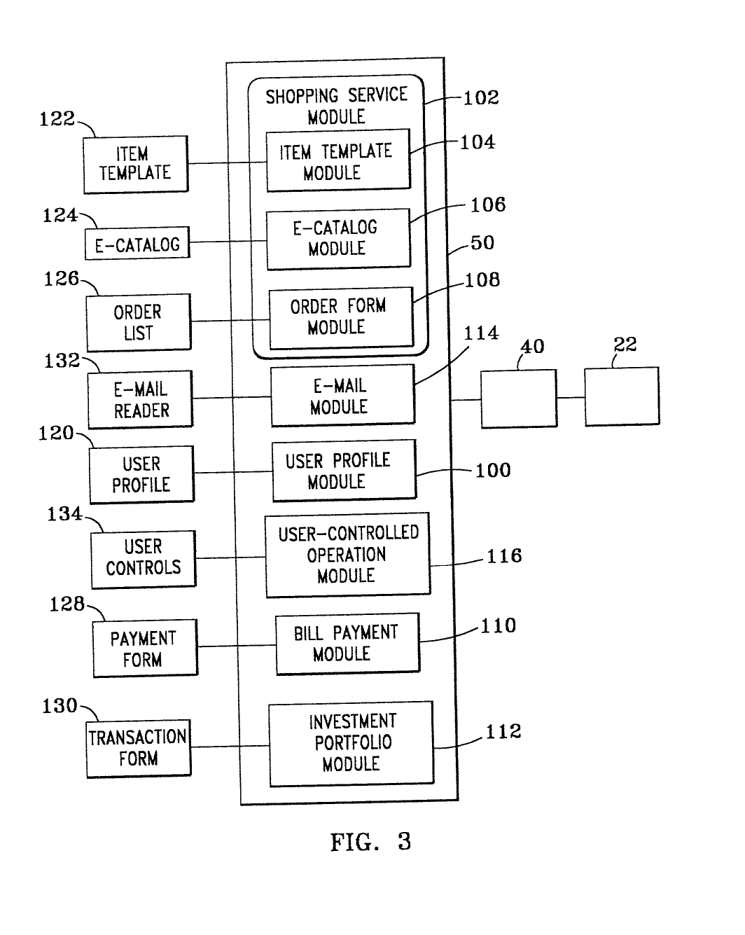

The home page for system 20 contains a directory (not shown) to two separate areas of information and data content for two classes of users: members and the public. Access to the members area requires entry of username and password information, while access to the public area does not. Most of the functionality of system 20, described below in detail, is provided in the members area. However, the public area includes information such as terms and conditions of use of the members area, a privacy policy, and a new member signup application. As discussed in more detail below and as illustrated in FIG. 3, application program 50 includes a user profile module 100 that controls operation of the new member signup process through, among other things, the provision of user profile 120 which is presented graphically in display 52. Included in user profile 120 are multiple fields in which the new member enters data such as name, billing address, shipping address, credit card number, username and password. As described below, information in user profile 120 is linked to orders placed to merchant sites 24, payment sites 25 and investment sites 26.

If desired, user profile module 100 may be designed to permit a user to allow others to access one or more e-catalogs 124 (described below) which the user has created. For example, a user may populate e-catalog 124 with birthday or wedding gift suggestions which he or she desires others to access for the purpose of obtaining gift ideas. Alternatively, a user may populate e-catalog 124 with approved office supplies or computer equipment that the users's co-workers may purchase as needed. To achieve this functionality, system 20 permits a user to designate specified e-catalogs 124 as either generally publicly available or available upon entry of a specified password (which preferably differs from the password used to enter the members area of system 20.) Should a third party desire to access such an e-catalog 124, he or she enters system 20 through the public area and then is provided the option of connecting to a navigation site that permits the third party to locate and review an e-catalog 124 created by the user.

All of the communication between a user computer 28 and the member area are preferably achieved using suitable encryption and data security protocols, as are communications between the user computer and merchant site 24, payment site 25 and financial site 26. Exemplary encryption and data security protocols are described in U.S. Pat. No. 5,557,518 to Rosen and in U.S. Pat. No. 5,671,279 to Taher, which are incorporated herein by reference.

B. Transaction Service Modules

As illustrated in FIG. 3, application program 50 of transaction service system 20 includes a plurality of modules which are operatively connected so as to perform the operations necessary to achieve the functionality of the transaction service system. These modules include a user profile module 100, as discussed above, and a shopping service module 102, which includes item template module 104, e-catalog module 106 and order list module 108. Application program 50 further includes bill payment module 110, investment portfolio module 112, e-mail module 114 and user-controlled operation module 116. As described in more detail below, each of these modules of application program 50 is responsible for performing various operations including controlling the content, operation, and graphical display of an associated tool. More particularly, these tools associated with the various modules include user profile 120 associated with user profile module 110, item template 122 associated with item template module 104, e-catalog 124 associated with e-catalog module 106, order list 126 associated with order list module 108, payment form 128 associated with bill payment module 110, transaction form 130 associated with investment portfolio module 112, e-mail reader 132 associated with e-mail module 114 and user controls 134 associated with user-controlled operation module 116. Modules 102-116 and their associated tools 120-134 are described in more detail below.

While various operations are performed by specific ones of modules 102-116, as described below, it is to be appreciated the present invention is not limited to the specific implementations described. Certain operations which are described as performed by one module may be performed by another. In addition, as those skilled in the act will appreciate, significant cooperation and interaction exists between modules.

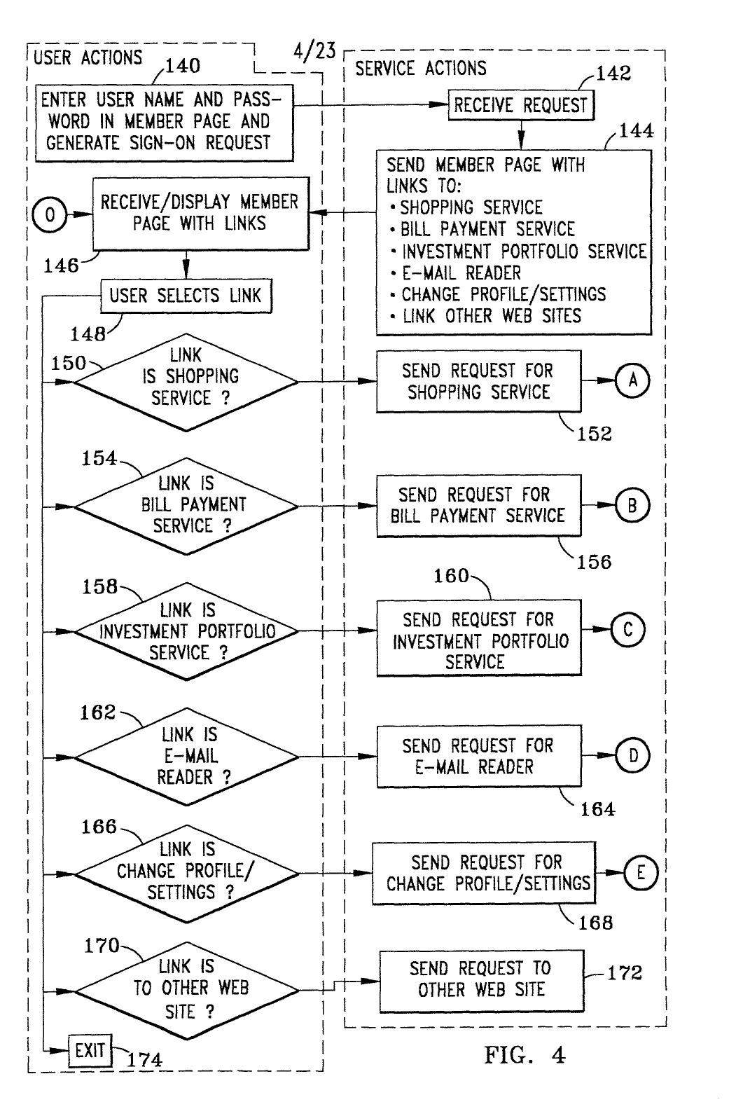

In connection with the following description of the operation of transaction service system 20, various figures, e.g., FIG. 4, contain diagrams illustrating the operation of system 20 in relation to other elements of computer network 30. In these diagrams, actions taken by browser 27 and user computer 28 occur in the column under the heading “User Actions,” operations performed by system 20 occur in the column under the heading “Service Action” and operations performed by a merchant site 24 occur in the column under the heading “Merchant Actions.”

Referring now to FIGS. 1, 3 and 4, to begin using transaction service system 20, at step 140 a user enters an appropriate usemame and password in the member page via browser 27 and user computer 28, which is transmitted via network 22 to system 20 where it is received at step 142 as a sign-on request. It is to be appreciated the actions performed at step 140 occur following some degree of communication between user computer 28 and system 20. This communication includes an initial connection between user computer 28 and system 20 and selection of the member page directory. Communications occurring across network 22 between these various entities are identified by arrows extending between operations in the User Actions, Service Actions and Merchant Actions columns.

When network 22 is the Internet, communication between and among system 20, user computer 28, merchant site 24, bill payment site 25 and investment site 26 is achieved using standard web-browsing protocols, e.g., HTML, JAVA, HTTP, TCP/IP. Much of this communication will be invisible to the user. However, as discussed below, in some cases email notes will be provided to the user in response to certain actions taken by the user. System 20 may be implemented in non-Internet environments as well as using communication protocols appropriate to the environment.

While not illustrated, user navigation tools such as icons, buttons and scroll arrows are provided to facilitate use of system 20. Typically these navigation tools are preferably provided in frame 54 and/or frame 56, although these tools may be provided elsewhere on display 52 of user computer 28.

Next, at step 144 system 20 sends a member page to the user with links to various modules of application program 50, i.e., shopping service module 102, bill payment module 110, investment portfolio module 112, e-mail module 114 and user-controlled operation module 116. The member page is received by user computer 28 at step 146 and depicted on display 52. Then, at step 148, the user selects one of the links provided in the member page. If the user selects link 150 to the shopping service, then user computer 20 at step 152 sends a request for the shopping service to system 20. If the user selects link 154 to the bill payment service, then user computer 28 sends a request at step 156 for the bill payment service to system 20. If the user selects link 158 to the investment portfolio service, then user computer 28 sends a request at step 160 for the investment portfolio service to system 20. If the user selects link 162 to the e-mail reader, then user computer 28 sends a request for the e-mail reader at step 164 to system 20. If the user selects link 166 for change profile/settings, then user computer 28 sends a request for change in profile/settings at step 168 to system 20.

If the user selects link 170 to another web site, then user computer 28 at step 172 sends a request to another web site following an entry of the appropriate URL by the user or activation of a hypertext link by the user. As a final option identified at step 174, the user can select to exit system 20.

C. Shopping Service Module

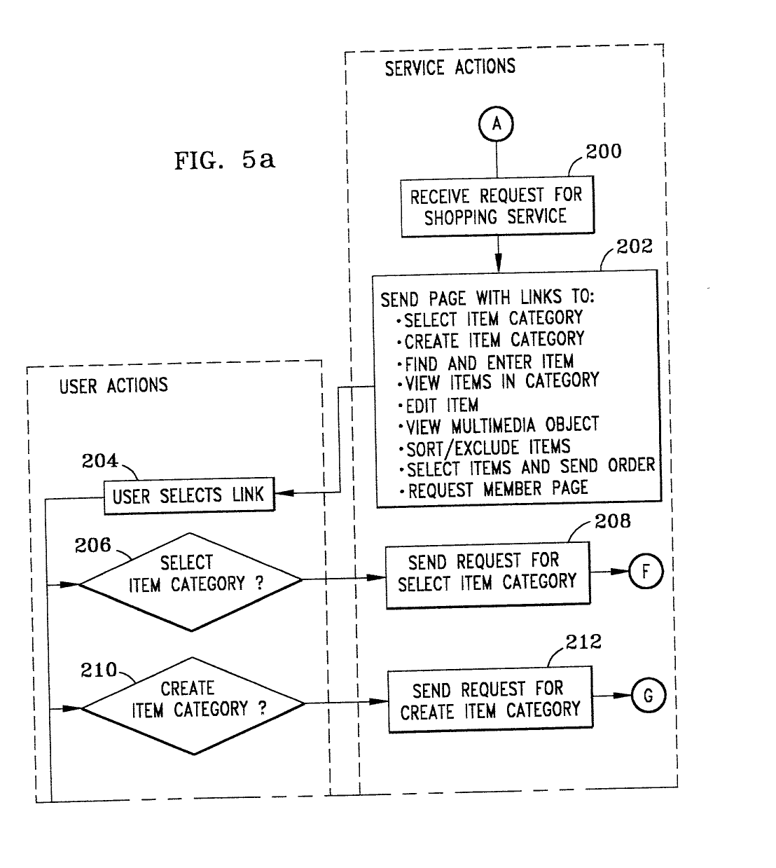

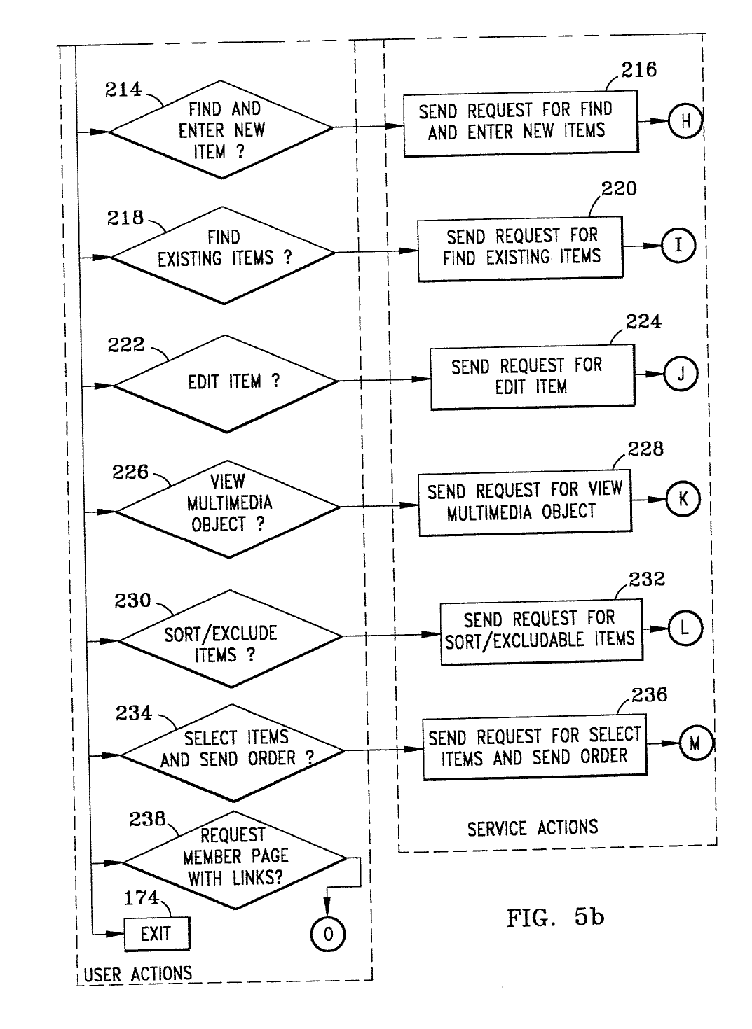

Turning next to FIGS. 4, 5a and 5b, following transmission of request for the shopping service at step 152 by user computer 28, transaction service system 20 receives this request at step 200 and then at step 202 sends a page to user computer 28 with links to these operations provided by shopping service module 102: select item category, create item category, find and enter item, view items in category, edit item, view multimedia object, sort/exclude items, select items and send order and request member page. At step 204, following receipt of the link page, the user selects a link to a given operation. If the user chooses select item category 206, user computer 28 sends a request at step 208 for select item category to system 20. If the user selects create item category link 210, then user computer 28 at step 212 sends a request for create item category to system 20. If the user chooses find and enter new item link 214, then user computer 28 at step 216 sends a request for find and enter new items to system 20. If the user selects find existing items link 218, then user computer 28 at step 220 sends a request for find existing items to system 20. If user selects edit item link 222, then user computer 28 at step 224 sends a request for edit item to system 20. If the user selects view multimedia object link 226, then user computer 28 at step 228 sends a request for view multimedia object to system 20. If the user selects sort/exclude items link 230, then user computer 28 at step 232 sends a request for sort/exclude items to system 20. If the user chooses select items and send order link 234, then user computer 28 at step 236 sends a request for select items and send order to system 20. Finally, the user may return to the member page with its links 150-170 by selecting link 238. Selection of this link returns the user to step 146. As an alternative, the user may select to exit system 20 at step 174.

Referring now to FIGS. 1-3, 5a and 6, before describing in more detail the result of selecting one of links 214-234, it is important to note that shopping service module 102 controls operation of various functions that facilitate e-commerce with multiple merchant sites 24 by providing an organizational framework for products and services, i.e., items, that a user is considering acquiring. These item categories may include, without limitation, hard goods such as pants, boats, and furniture, services such as automobile repair services and home maintenance services, and digital data which may embody music, software, printed materials, videos and other information which may be represented digitally. Such other information may include, for example, book reviews, business articles, medical records and weather forecasts. While items acquired by merchant sites 24 will typically be purchased, system 20 is also adapted to permit users to acquire information by license. This is particularly true for items obtained in the form of digital data downloaded to user computer 28, e.g., software and music. Shopping service module 102 may be used to acquire items offered by a merchant site 24 at a fixed price or in an auction format. Also, items may be offered for free, e.g., a free sample of a new product or information that can be delivered digitally to user computer 28, e.g., “other information” of the type discussed above.

Shopping service module 102 is sufficiently flexible that a user need not organize items by category if he or she so chooses. In such case, all items are organized in a generic item category. In any event, each item category has an associated item template 122 (FIG. 3) containing multiple fields 250 (FIG. 2) of information pertaining to the given item category, including a multimedia object field 252 (FIG. 2). For example, if the item category is mens shirts, fields 250 in item template 122 for such item category may include neck size, sleeve length, color, type, material, manufacturer, and URL for the merchant site 24 selling the shirt, with multimedia object field 252 containing a visual depiction of the shirt or an audiovisual advertisement of the shirt. Typically, an identifier is provided adjacent a given field 250, e.g., sleeve length above the field for this information. Shopping service module 102 includes a number of predefined item templates for common item categories, and also permits the user to create his or her own custom templates as discussed below. If no item categorization is desired, then a generic template is provided with a series of unlabeled fields 250.

Templates 122 are the means by which a user enters items into his or her e-catalog 124. As described in more detail below, following entry of an item into item template 122, item template module 104 adds the item to user's e-catalog 124 for a given item category. In this way, e-catalogs 124 directed to specific items such as coats, soccer balls, skis and automobile repair services are available for use. In one implementation of the present invention, a single e-catalog 124 is created for each user, with each item being tagged by an item category identifier. When a user selects an item category, as described below, an e-catalog is generated containing the corresponding tagged items. It thus appears to the user, and for the purposes of the discussion below, that a unique e-catalog 124 for the item category selected.

E-catalog 124, which is preferably displayed in frame 56, lists some or all of the fields for a limited number, e.g., 3-5, of items in the e-catalog. As described below, the specific items depicted depend on sort and exclude operations performed by the user and hierarchical parameters of shopping service module 102. However, for example, one of the items in e-catalog 124 depicted in frame 56 may be jeans from XYZ company, in a given color, having a given size, a given product number, and from a merchant site 24 having a specified URL. Only one item in frame 56 is depicted for ease of illustration. Following this introductory description of item templates 122 and e-catalogs 124, the manner in which the templates and e-catalogs are created, modified and used is described in detail.

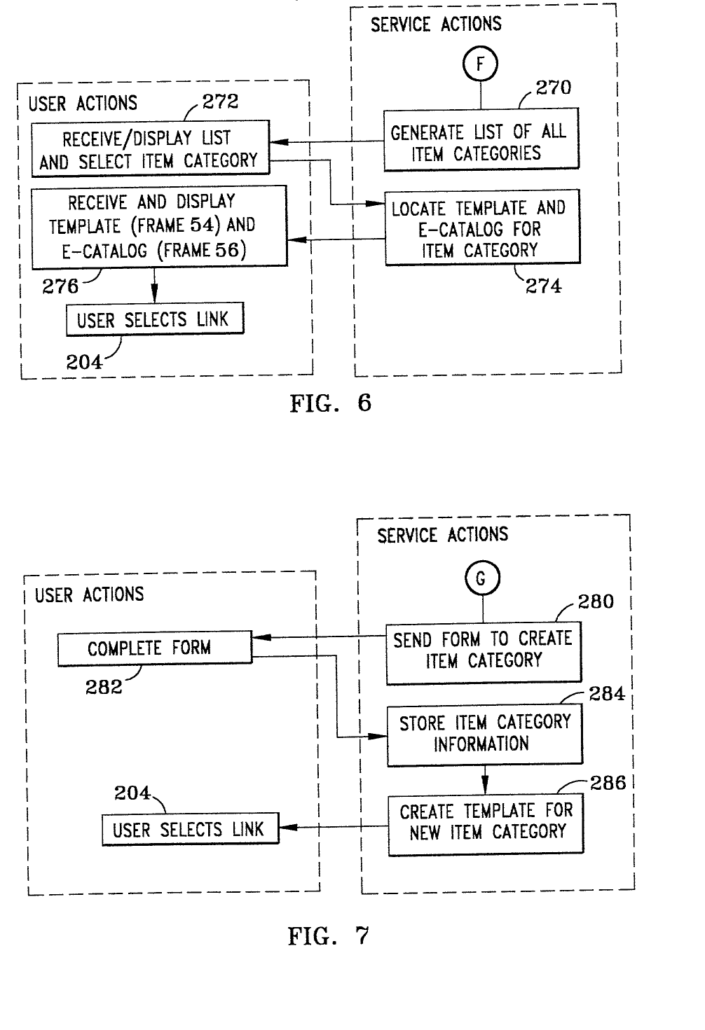

Referring next to FIGS. 3a 5a and 6, after user computer 28 at step 208 (FIG. 5a) sends a request for select item category to system 20, the latter invokes operation F which starts at step 270 (FIG. 6). There, system 20 generates a list of all existing item categories, which it sends to user computer 28. At step 272, user computer 28 receives and displays the list and the user selects one of the item categories listed which is then transmitted to system 20. Next, at step 274, system 20 locates the associated item template 122 and e-catalog 124 for the selected item category and sends the item template and e-catalog to the user computer. Then, at step 276, the user computer receives and displays the template, preferably in frame 54, and displays several of the e-catalog items, preferably in frame 56. At step 204, the user then selects a link to other shopping service functions.

Turning now to FIGS. 2, 3, 5a and 7, as noted above system 20 includes a number of predefined item templates 122 for common item categories. However, to enhance the flexibility of system 20, the opportunity exists for a user to create new item categories and associated item templates 122. In this regard, if user computer 28 sends a request at step 212 (FIG. 5a) to create an item category, in response thereto system 20 invokes operation G which begins at step 280. There, system 20 generates and sends a form to user computer 28 which enables the user to create a new item category. At step 282, the user completes the form by naming the item category and identifying the various fields to be included in the template 122 for the item category. Following receipt of the completed form from user computer 28, at step 284, system 20 stores the item category and creates an item template 122 for the new item category, as indicated at step 286. Thereafter, at step 204 the user selects a link to another function.

The number of users purchasing goods and services over the Internet via e-commerce has increased dramatically in recent times. However, comparison shopping among various merchant sites 24 is difficult because merchant sites do not typically provide a way for users to segregate items of interest for future purchase. In addition, because items offered by a given merchant site 24 disappear from display 52 of user computer 28 as soon as the user links to another merchant site, it is difficult to compare similar items offered by different merchant sites. By contrast, with printed catalogs a user can comparison shop by spreading the catalogs on a table and then refer back and forth to items of interest in the catalogs. To perform similar comparison shopping with respect to items offered in e-commerce at merchant sites 24, it is generally necessary for a user to write down on a piece of paper, print out web pages or type into another computer operating nearby the pertinent information with respect to items of interest for each merchant site. Then by comparing the handwritten, printed or computer-entered information, selected items could be purchased on a merchant site-by-merchant site basis. Transaction service system 20 overcomes this inability to readily comparison shop for items offered by different merchant sites 24 by permitting a user to enter items of interest from any number of merchant sites into the user's e-catalog 124.

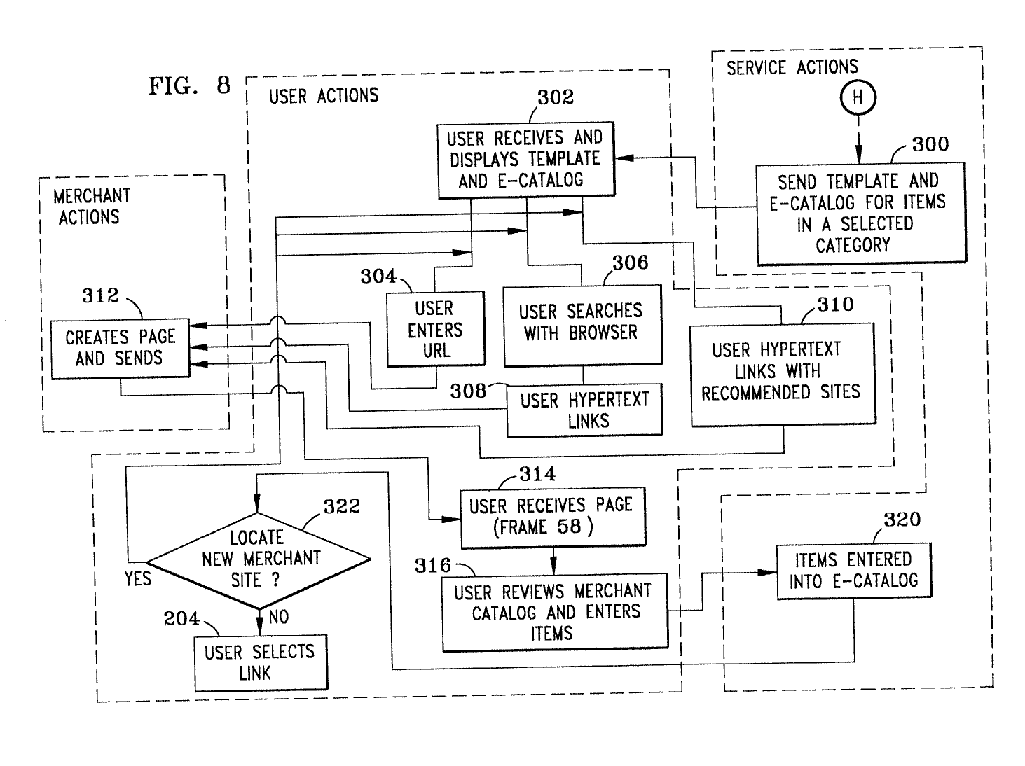

With reference to FIGS. 2, 3, 5b and 8, when a user desires to perform comparison shopping in preparation for the purchase of items, the user selects find and enter new item link 214 (FIG. 5b), which results in user computer 28 sending a request for find and enter new items, as identified by step 216, thereby invoking operation H by system 20. Typically this request is sent after a user has selected an item category at step 272 or has completed a form to create a new item category at step 282. If an item category has not been selected, system 20 following receipt of the request sent by user computer 28 at step 216, provides links 206 and 210 to the user to permit selection of an item category (these latter link options are not illustrated in FIG. 8).

In any event, once the user has selected an item category, at step 300 system 20 locates the item template 122 and e-catalog 124 for the selected item category, and sends the item template and e-catalog to user computer 28. At step 302, user computer 28 receives item template 122 and e-catalog 124, and displays the item template in frame 54 (FIG. 2) and several items in e-catalog 124 in frame 56. If no items have been selected to date with respect to the item category, then no items are displayed in frame 56.

At this juncture, comparison shopping can be initiated in at least three ways. If the user knows the URL for the merchant site 24 of interest, then at step 304 the user enters the URL with browser 27, which then effects the link with the selected merchant site. Prior to linking with merchant site 24, browser 27 appears in frame 58 of display 52. As an alternative, represented at step 306, the user may search for web sites with browser 27 by entering appropriate search commands such as the names of merchant sites of interest. Also with this approach, browser 27 is displayed in frame 58. As a result of this search performed at step 308, a number of “hits” are typically obtained and displayed in frame 58. The user can then hypertext links to merchant sites of interest. As yet another alternative, identified by step 310, transaction service system 20 may be designed to list a number of selected merchant sites 24, and associated hypertext links. These pre-selected merchant sites are displayed in frame 58. After reviewing the list, the user may access a merchant site of interest by hypertext linking. Content provided by merchant site 24 and displayed in frame 58 is viewable at the same time content in frames 54 and 56 may be viewed.

Regardless of whether the user following step 302 selects step 304, 306 or 310, the result is the user computer 28 is linked to a selected merchant site 24, as depicted at step 312. Following this link, the merchant site 24 creates a home page and sends it to user computer 28. At step 314, the user computer 28 receives the home page and displays it in frame 58. At this stage, system 20 has set up user computer 28 so that comparison shopping within a merchant site 24 and between various merchant sites 24 can be easily and effectively accomplished. In this regard, a user may navigate within a given site 24 to find items of interest using browser 27 of user computer 28.

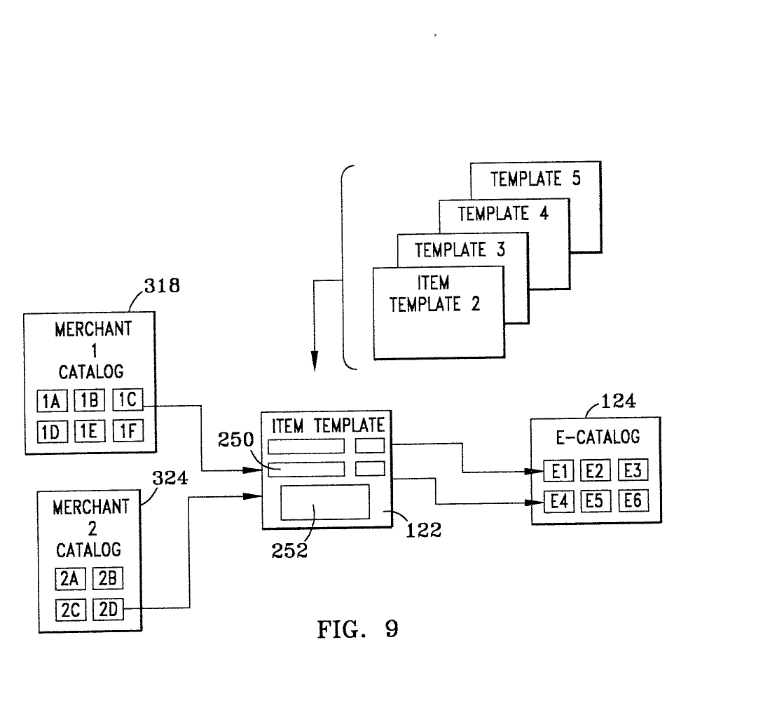

Referring now to FIGS. 2, 8 and 9, at step 316 the user reviews the catalog 318 (FIG. 9) of the selected merchant site 24. Once an item of interest is located, the user then enters pertinent information for the item in fields 250 and 252 of item template 122. Next, at step 320, system 20 enters information from the item template 122 into the user's e-catalog 124 for the selected item category. Such information is entered by typing, dragging and dropping, copying, using voice recognition programs or otherwise entering the information into fields 250 and 252 of item template 122. As an example of this process by which items from catalog 318 of a given merchant site 24 are entered into the user's e-catalog 124, assume a user is interested in collecting information for item 1C in catalog 318. Pertinent information for item 1C, which is displayed in merchant catalog 318 is, for example, typed into fields 250 of item template 122. This entry of information is made easy by providing item template 122 for viewing in frame 54 so that merchant site catalog 318 may be viewed in frame 58, whereby the user may simultaneously view both the item template and the merchant site catalog.

Once the user has populated the fields 250 and/or 252 of item template 122, the information contained in these fields is automatically transferred into the user's e-catalog 124, as depicted by step 320. Thus, item IC in merchant site catalog 318 becomes entry E1 in e-catalog 124. The user may repeat the operations in steps 316 and 320 and depicted in FIG. 9 multiple times with respect to a given merchant site catalog 318. System 20 provides a new item template 122 for each item the user wishes to enter in e-catalog 124, as indicated by templates 2-5 in FIG. 9. If desired, the user may print portions or all of e-catalog 124 at this or other stages in his or her use of system 20.

Following entry of all items of interest from a given merchant site 24 into e-catalog 124, system 20 provides the user with the option of locating a new merchant site, as identified by step 322. The user may then select a link to another function, as identified by step 204, or may link to a new merchant site following one of steps 304, 306 or 310 discussed above. Once a new merchant site 24 is linked to user computer 28, the user reviews and selects items from the merchant site catalog 324 (FIG. 9) for that merchant site and enters them into template 122, which causes them to be entered into e-catalog 124 as described above. For example, if a user is interested in saving information concerning item 2D in merchant site catalog 324 in his or her e-catalog 124, this information is entered into item template and is then transferred into the e-catalog as item E4. Thus, a powerful feature of system 20 is that it permits a user to quickly and easily store information regarding items from multiple merchant sites 24 in the user's e-catalog 124 for a given item category, including, as noted above, a generic item category.

In some cases a user may desire to access an item previously entered in e-catalog 124. For example, before ordering an item, editing an item or comparing the item to other items, it is necessary to locate the item from among the tens, hundreds or even thousands of items in e-catalog 124. Referring to FIGS. 1-3, 5a, 8 and 10, to find an existing item in e-catalog 124, the user selects link 218 (FIG. 5a), thereby causing user computer 28 at step 220 to send a request to system 20 to find an existing item. Following receipt of this request, which invokes operation I, system 20 at step 340 sends an item category list to user computer 28. An advantage of organizing items in specific item categories, as described above, is that location of a previously entered item is facilitated. Next, at step 342 the user selects an item category from those included in the list and sends the selection back to system 20. Then at step 344, system 20 locates item template 122 for the selected item category and e-catalog 124 for the selected item category, and then sends the template and e-catalog to user computer 28.

Following receipt by user computer 28 of the template 122 and e-catalog 124 provided by system 20, as indicated by step 346, the user then locates the item of interest in one of two ways. First, as indicated by step 348, the user may scroll through the e-catalog 124 until he or she locates the item of interest, as indicated by step 350. Alternatively, at step 352, the user may request a browser (not shown) from system 20, which is provided by the system so as to preferably be displayed in frame 58. Then the user may search for an item by entering in the browser in an appropriate search parameter, such as the name of the product, the name of the merchant site 24 from which the item was obtained, or the URL of the merchant site. Following receipt of the search request, at step 354 system 20 conducts a search in the e-catalog 124 to locate all items corresponding to the search parameter(s) provided by the user. At step 355, all search results are organized and provided to user computer 28. At step 356 user computer 28 receives the search results, which are typically displayed in frame 58. Thereafter at step 358, the user reviews the search results and locates an item of interest. The user then can perform follow-on activities with respect to the located item, e.g., order the item as described below by selecting an appropriate link at step 204, print portions or all of e-catalog 124 or edit the item, as described below.

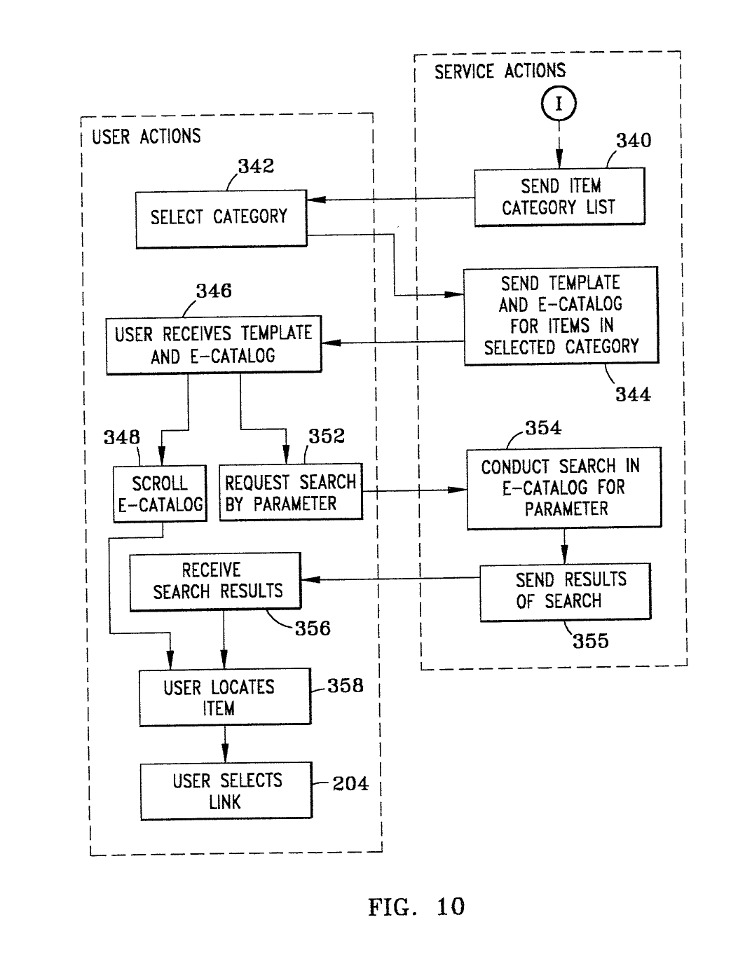

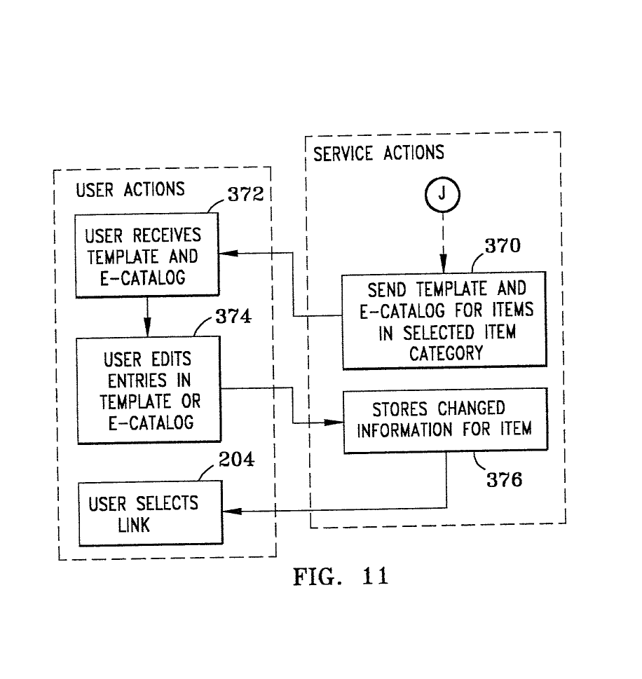

An activity that frequently follows location of a given item at step 350 is editing of the item, either as a prerequisite to purchase of the item or for purposes of accurately listing information for a given item in template 122 to facilitate comparison shopping. Turning next to FIGS. 1-3, 5b and 11, when a user desires to edit an item in his or her e-catalog 124, the user selects link 222 (FIG. 5b) which results in user computer 28 sending a request at step 224 to system 20 for item editing. Following receipt of the edit item request, which invokes operation J, at step 370 system 20 sends the item template 122 and e-catalog 124 for an item category selected by the user prior to step 370, e.g., at step 342 (FIG. 10) or at step 272 (FIG. 6). These steps are omitted from FIG. 11 in the interest of brevity. Following receipt and display of the item template 122 and e-catalog 124 in frames 54 and 56, respectively, as indicated by step 372, the user at step 374 edits items in the e-catalog by typing in a change, dragging and dropping information from a merchant site 24 displayed in frame 58 or otherwise changing information associated with a given item. Item template module 104 (FIG. 3) and e-catalog module 106 (FIG. 3) are preferably implemented and linked so that when a user selects a given item, by either scrolling to the item, moving a cursor in display 52 to the item or otherwise identifying the item as may be permitted by system 20, the information in fields 250 (FIG. 2) and 252 (FIG. 2) are automatically displayed in the item template 122 associated with the selected item. Changes to information in fields 250 and 252 may be made either by entering the changes in item template 122 depicted in frame 54 or by entering the changes in the items of e-catalog 124 depicted in frame 56. Thus, a change to an item in e-catalog 124 automatically causes a change in the associated template for the item and visa versa. After editing of the item at step 374 is complete, user computer 28 sends the edited information to system 20 which updates and stores the new information for the item, at step 376. Thereafter, system 20 provides user with the option of selecting another link at step 204.

To permit effective comparison shopping, and otherwise enhance the utility of the shopping service functions of the present invention, system 20 permits a user to save a multimedia object for each item in e-catalog 124. Typically, the multimedia object will be a photograph or other graphical representation of an item of interest, in two dimensional or three-dimensional representation, including rotating three dimensional representation. However, the multimedia object may consist of audio information or audio and visual information with respect to the item. As described in more detail below, the multimedia object may be displayed in frame 54 as multimedia object 252, may be displayed so as to occupy the entire frame 58, or multiple small or “thumbnail” multimedia objects may be displayed in frame 58. In the latter case to facilitate comparison shopping, it may be desirable to simultaneously view multiple thumbnail multimedia objects for a limited set of items a user is contemplating purchasing. Known audio and video data comparison is preferably employed to reduce the file size of the multimedia object stored by system 20.

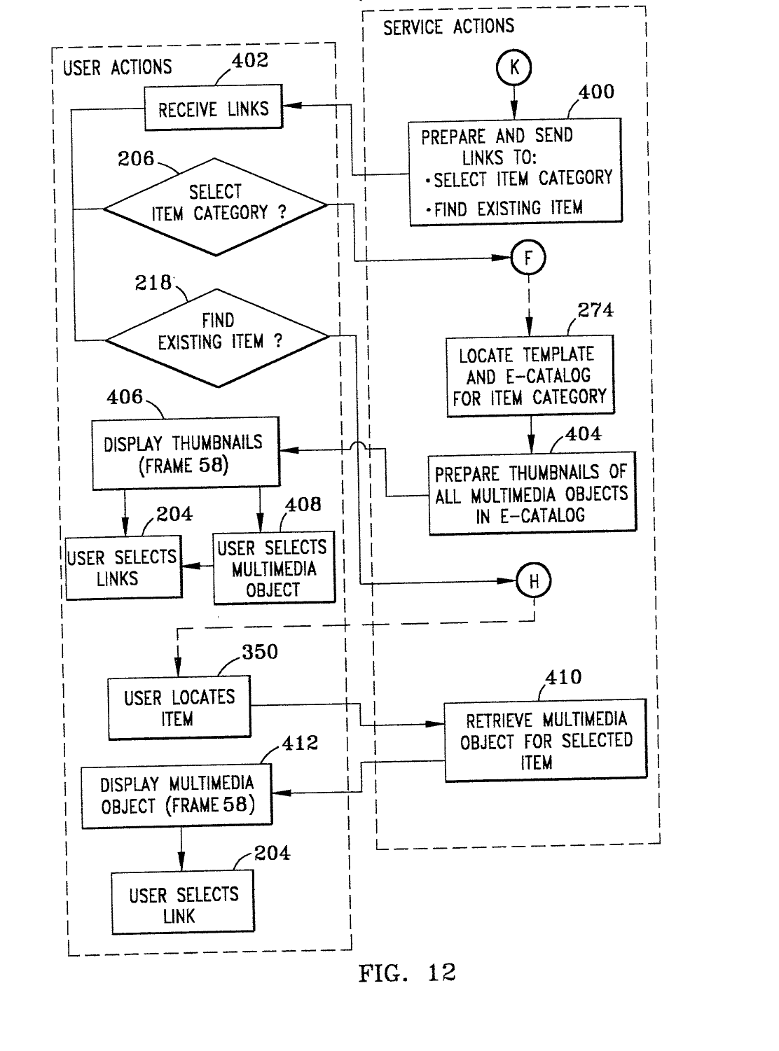

Referring to FIGS. 1-3, 5b, 6 and 12, if a user desires to view a multimedia object associated with one or more items in e-catalog 124, the user selects link 226 (FIG. 5b), thereby causing user computer 28 to send a request at step 228 to system 20 to view multimedia object. Following receipt of this request, which invokes operation K, at step 400, system 20 prepares and sends select item category link 206 and find existing item link 218 to user computer 28, which is received at step 402 and displayed in frame 58. Then, the user selects one of these links. If the user chooses select item category link 206, system 20 processes this link as described above and illustrated in FIG. 6, including the step 274 of locating an item template 122 and e-catalog 124 for the item category selected by the user. In this regard, steps 270 and 272 are omitted from FIG. 12 in the interest of brevity. Shopping service module 102, knowing that the select item category link 206 followed selection of the view multimedia object link 226, prepares thumbnails for all multimedia objects in the e-catalog for the selected item category at step 404. These thumbnails are provided to facilitate comparison and selection multimedia objects by the user. At step 406, user computer 28 receives the thumbnails generated by system 20 and displays them in frame 58. Should the user desire to view an enlarged version of a given thumbnail, the user selects a given multimedia object at step 408, e.g., by moving a cursor to the multimedia object and clicking or otherwise by selecting the multimedia object, which, although not illustrated, causes system 20 to provide an expanded version of the multimedia object which fills frame 58. Using the “back” button (not shown) in browser 27, the user can return to the thumbnails for further comparison. Alternatively, the user may select other links at step 204.

Should the user select find existing item link 218, then system 20 processes this link as described above and illustrated in FIG. 10. These steps are not repeated here in the interest of brevity. Ultimately, at step 350 the user locates an item of interest, as described above. Because such item has been located following selection of view multimedia object link 226, system 20 knows to retrieve the multimedia object for the selected item at step 410 and then provides the multimedia object to user computer 28 for display in frame 58. Thereafter, the user selects another link at step 204.

If desired, system 20 may be implemented so that items in e-catalog 124 are continuously organized in some hierarchy by e-catalog module 106. Time and date of entry, with the most recent information last, is a preferred hierarchical scheme. However, price, URL and other schemes may be used. This organization function may operate with, subordinate to or in other relationship with the sort/exclude functions described above, as desired.

System 20 permits a user to organize items in his or her e-catalog 124 so as to facilitate comparison shopping, actual purchasing of items and other activities. Referring to FIGS. 1-3, 5b and 13, if a user desires to organize items in his or her e-catalog, the user selects sort/exclude items link 230 (FIG. 5b), which results in user computer 28 sending a request for sort/exclude items, at step 232 to system 20. Following receipt of this request, which invokes operation L, at step 420 system 20 generates a list of all item categories. After user computer 28 receives this list and displays it in frame 58, at step 422, the user selects an item category. Then, at step 424, system 20 generates and sends a page with links to sort by price, sort by merchant URL, sort by date added or modified, exclude by price, exclude by merchant URL, and exclude by date range. Other sort and exclude operations may be provided as desired. Following receipt of this page at step 426 by user computer 28, the user selects one or more of these operations and provides relevant parameters, e.g., price, if the sort by price operation is selected. At step 428, system 20 performs the sort or exclude operations requested at step 426 and prepares a list of all items meeting the operation parameters and sends the result to user computer 28, where at least some results are displayed in frame 56, as indicated by step 432. All results are obtainable by scrolling or otherwise moving through the list of items. Thereafter, at step 204 the user selects another link.

As discussed above, one important drawback with existing electronics malls, e-commerce systems at merchant sites 24 and other on-line shopping services is that it is typically not possible to order items from more than one merchant site in a single transaction, i.e., by submitting a single order form. Another important drawback, as also noted above, is that only hard goods are typically available at electronic malls, not information such as business articles, industrial research reports, and items downloadable in digital form such as software, music and financial data. Shopping service module 102, and in particular order list module 108 of system 20, is designed to overcome these limitations. As described in detail below, shopping service module 102 permits a user to order any number of items present in the user's e-catalog 124, from any number of merchant sites 24, as a single operation.

Referring to FIGS. 1-3, 5b, 14a and 14b, when a user has reached a point where he or she is ready to order items in e-catalog 124, the user chooses select items and send order link 234 (FIG. 5b), which results in user computer 28 at step 236, sending a request for select items and send order to system 20. This action invokes operation M. Following receipt of a request for select items and send order, shopping service module 102 and more particularly item template module 104, generates an order list 126 at step 500 (FIG. 10) to enable the user to order items, and sends the list to user computer 28. Order list 126 includes multiple fields for information pertinent to items the user orders. For example, if the user is ordering a men's shirt, the user will enter in order list 126 information like neck size, sleeve length, color, collar type, product number, price and quantity.

Once a user has identified the items he or she wants to purchase through the use of find existing item link 218, sort/exclude items link 230, or in other ways, the user selects items for purchase at step 501. Order list module 108 of shopping service module 102 may provide different user input options for selecting items to be purchased. However, in one embodiment, a select item box 502 (FIG. 2) is included in each item entry for those items in e-catalog 124 displayed in frame 56. With this implementation, the user may, for example, select an item by moving the cursor of display 52 to box 502 and then clicking a left mouse button. Preferably, order list module 108 identifies which items have been selected by changing the color, entering an “X” or otherwise indicating a change in box 502. As those skilled in the art will appreciate, other techniques may be implemented for allowing a user to select items in e-catalog 124 to be purchased.

Following the user selection of items at step 501, system 20 builds an order list of those selected items at step 503. Then, at step 504, all required fields 250 for each item are evaluated to verify appropriate information exists in such fields. For example, if an item to be purchased is women's shoes and the field 250 in item template 122 for shoe size is missing or is listed as “79,” order list module 108 identifies this missing information. At step 506 an order list 126 containing all selected items is generated and any missing information in the selected items are highlighted or otherwise identified to permit the user to complete such information. In connection with generating order list 126 at step 506, system 20 presumes the user intends to order a single item and so provides an item quantity of “1” in the order list. System 20 then sends this order list to user computer 28 where, at step 508, it is received and displayed in frame 58. At step 510 the user enters greater quantities for the items included in the order list 126, if desired, and/or completes any missing fields highlighted by system 20 at step 506. This information is then sent by user computer 28 to system 20 where, at step 512, order list 126 is updated. For services, order list 126 contains information relevant to specific services of interest, e.g., date services are to be performed, and a description of key aspects of the services to be performed.

Next, the total cost of the items in order list 108 is compared with a budget earlier established by the user and a notice is generated if the cost of the items exceeds the budget, as depicted at step 514. While the steps for providing a budget comparison are not illustrated or described in detail, those skilled in the art will appreciate that such operation may be provided on an item category-by-item category basis, may be created by time period, e.g., by month, or may be an absolute number. At step 516, system 20 generates a revised order list 126 based on the input provided by the user at step 510 and adds to the order list any notices generated at step 514 with respect to budget overages. System 20 then sends this order list and any notices to user computer 28 where it is received at step 518. Next, at step 520 the user is given the option to order, edit or cancel items. In addition, the user can exit system 20 and place orders directly with merchant sites 24, all as described below.

With reference to FIGS. 1, 5a and 14a, the user elects to edit the order, for example to delete items based on a budget overage notice, such editing occurs at step 522 and then the edited order list is provided to system 20 at step 503, where a new order list is built. The operations described above follow this return to step 503. Alternatively, if the user desires to cancel the order, a cancellation notice is generated by user computer 28 and is provided to system 20 at step 524 which, at step 525, cancels the order. Thereafter, the user selects a new link at step 204. As yet another alternative, as identified at step 526, the user may place an order for the items on the order list directly with the various merchant sites 24 by telephone. Step 526 follows step 520 by a dotted line because system 20 is not involved in such ordering of items. After placing such an order, the user then can select new links at step 204. As yet a further alternative following step 520, the user may order items on the order list directly with a merchant site 24 using the e-commerce program 62 (FIG. 1) of the merchant site, as indicated by step 528. In this regard, the user would typically hypertext link to the merchant site 24 relying on the URL field for each item in the order list to achieve such linking. The disadvantage with this approach is that a separate order needs to be placed for each merchant site 24 having items included in order list 126. Step 528 follows step 520 with a dotted line because system 20 is not directly involved when the user places an order directly with a merchant site 24. Thereafter, at step 204 a user may select another link.

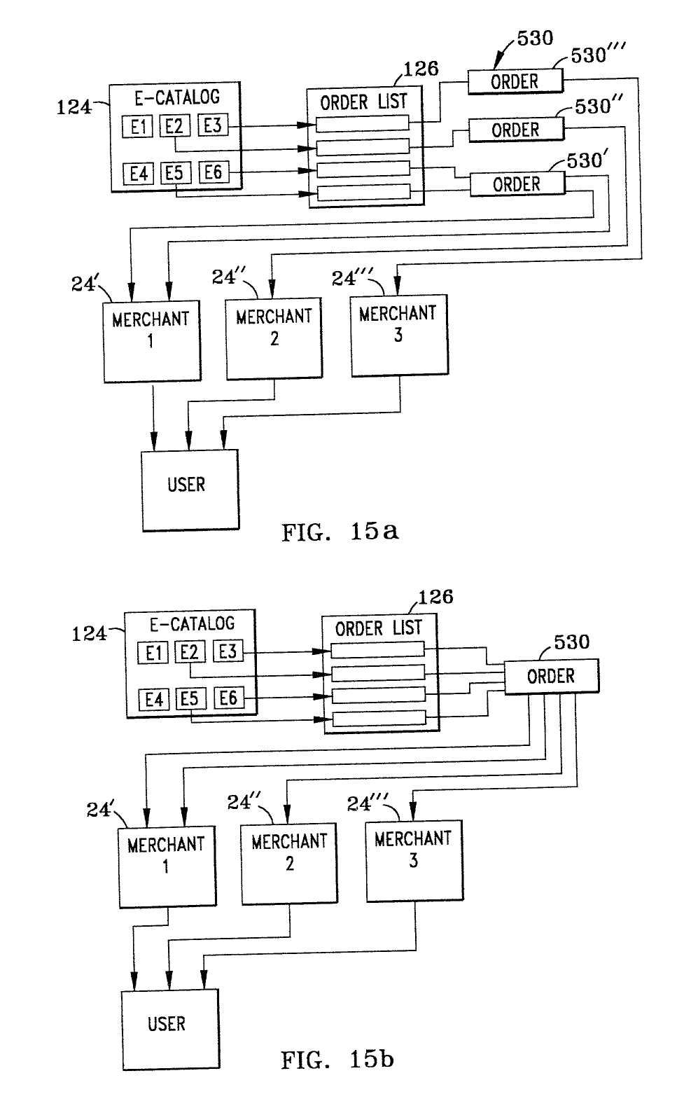

Referring now to FIGS. 1-3, 14a, 14b and 15a, if the user elects to place an order for items on order list 126 directly with merchant sites 24 as provided in steps 526 and 528, the order list provides a single listing of items the user desires to purchase. This makes it easier for a user to purchase items, much like a shopping list facilitates shopping in a supermarket or conventional shopping mall. However, when the user purchases items directly from merchant sites 24, he or she will need to place separate orders 530 (FIG. 15a) with each merchant site. Thus, the user will need to place an order 530 to merchant site 24′, an order 530″ to merchant site 24″ and an order 530′″ to merchant site 24′″. Following receipt of these orders 530, merchant sites 24 then deliver the purchased items to the user.

To take full advantage of the functionality offered by transaction service system 20, at step 520 a user orders items on order list 126 by placing an order at step 540 for the items on order list 126, which is conveyed to system 20 by user computer 28. At step 542, system 20 generates a standard e-mail order message (SEOM) for each merchant site 24 having items included in order list 126. Next, at step 544, each SEOM is added to an outgoing queue of SEOMs. Then, at step 546, system 20 reads the first SEOM in the queue and at step 548 retrieves the data in fields 250 and 252 in item template 122 associated with the items included in the SEOM. This data comprises the information in fields 250 of template 122 necessary to complete an order. Next, at step 550, system 20 retrieves user profile and payment information from user profile module 110 and links it with the item order information obtained at step 546.

Next, at step 552, system 20 retrieves the e-mail address of the merchant e-mail order administrator (MEOA) for the merchant site 24 to which the SEOM prepared at steps 546-550 is directed from information in item templates 122 associated with the items in order list 126. After creating a unique identification number at step 554 for the SEOM, system 20 completes assembly of the SEOM and sends it to the MEOA, as depicted by step 556. Typically, but not necessarily, the MEOA is at the merchant site 24 to which the SEOM is directed.

Following receipt of the SEOM by the MEOA, as indicated at step 570, the merchant site 24 retrieves and processes the SEOM at step 572. This processing includes assessing if the ordered items are in inventory or otherwise available, assembling and packing the ordered items that are available, and arranging for delivery of the items. In the case of items that are deliverable electronically, e.g., software, the assembly, packing and delivery steps involve retrieving the items from memory, assembling an e-mail message with the software as attachments, and sending the e-mail message. For items that are services, e.g., window washing, merchant site 24 arranges for delivery of the services at the time and location specified in the SEOM.

Next, at step 574, a warranty for the item may be generated and a description of extended service contract offerings may be created when appropriate for the items delivered. This description includes a form to enable the user to select one of the extended contract offerings available. In addition, a message to the user is prepared identifying which of the items in the SEOM are no longer available, are not available in the color, size, and other specifications requested, are on backorder or for other reasons cannot be provided in the form set forth in the SEOM. This message also includes confirmation of the items in the SEOM that have been shipped to the user. In the case of services, the message may specify when the services were performed. In addition, a questionnaire is generated and included in the message to enable the user to provide direction as to what he or she wants to do with respect to the items not currently available for delivery. The message together with the warranty and extended service contract offerings are then sent by merchant site 24 to transaction service system 20 where it is received at step 576. In addition for items such as software, articles, and music which are licensed rather than sold (and are typically delivered electronically), a license agreement, e.g., a “click-wrap” agreement, may also be provided as part of the message.

Then, at step 578, the message, warranty and extended service contract offerings are sent to the e-mailbox 132 (FIG. 3) of the user which is typically provided in frame 58, and are received by user computer 28 at step 580. The user then, at his or her option, completes the questionnaire, files the warranty using a “warranty file” prompt provided by system 20, completes the extended service contract form if extended service for the item is desired and, if provided, indicates acceptance of the terms of the license agreement. Following completion of these actions, user computer 28 sends the questionnaire, warranty, extended service contract form, to the extent completed by the user, and executed license agreement, if provided, to system 20.

Thereafter, at step 584 system 20 files the warranty in a warranty file for the user, and generates another SEOM containing the completed questionnaire, extended service contract form, warranty and license agreement, and provides this SEOM to merchant computer 28. Merchant site 24 receives this SEOM at step 586 and processes any new orders for items in the questionnaire, e.g., sends an item in a different color than earlier ordered, as described above. Also at step 586, merchant site 24 enters the extended service contract information contained in the form in its database and generates the actual service contract for the user. In addition, merchant site 24 may enter in its database the warranty and executed license agreement. Then at step 588 merchant site 24 generates a new message containing an order confirmation and the extended service contract requested in the form by the user. This message is then sent to system 20, where it is received at step 590, sent to the user's e-mailbox at step 592, and received at step 594 by user computer 28.

The process described above and illustrated in steps 542-594 is repeated for each merchant site 24 sourcing items in the queue developed at step 544. Thus, while from the perspective of the user a single order is submitted at step 540, behind such submission system 20 is generating and delivering a unique SEOM for each merchant site 24 providing items included in order list 126.

Referring now to FIGS. 3, 14b, 15a and 15b, the result of selecting step 540 after step 520, rather than steps 524 or 526, is illustrated in FIG. 15b. Placing an order for the items in order list 126 at step 540 results, from the user's perspective, in a single order 530 being generated. Order 530 is then broken up and distributed in SEOMs to merchant sites 24′, 24″ and 24′″ in a way that is invisible to the user. As described above in reference to FIG. 15a, from the user's perspective separate orders 530′, 530″ and 530′″ must be submitted to obtain all items in order list 126 if steps 524 or 526 are selected.

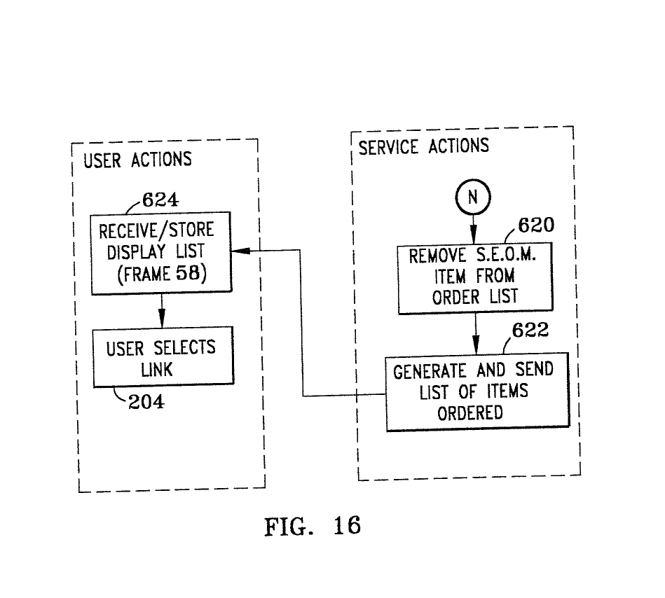

Referring now to FIGS. 5b, 14b and 16, after system 20 submits each SEOM to the outgoing queue at step 544, it then removes the items from order list 126 at step 620. Next, at step 622, system 20 generates a list of all items ordered and sends the list to e-mailbox 132 which is received by user computer 28. Following receipt of this list at step 624, user computer 28 displays the list in frame 58. Then the user can select another link at step 204.

This completes a description of the functionality and operations of shopping service module 102 of application program 50. Should the user desire to link to other service areas provided by system 20, then at step 238, following selection of link step 204, the user can request the member page with the link provided at step 146 (FIG. 4). Alternatively, the user can elect to exit system 20, at step 174.

D. Bill Payment Module

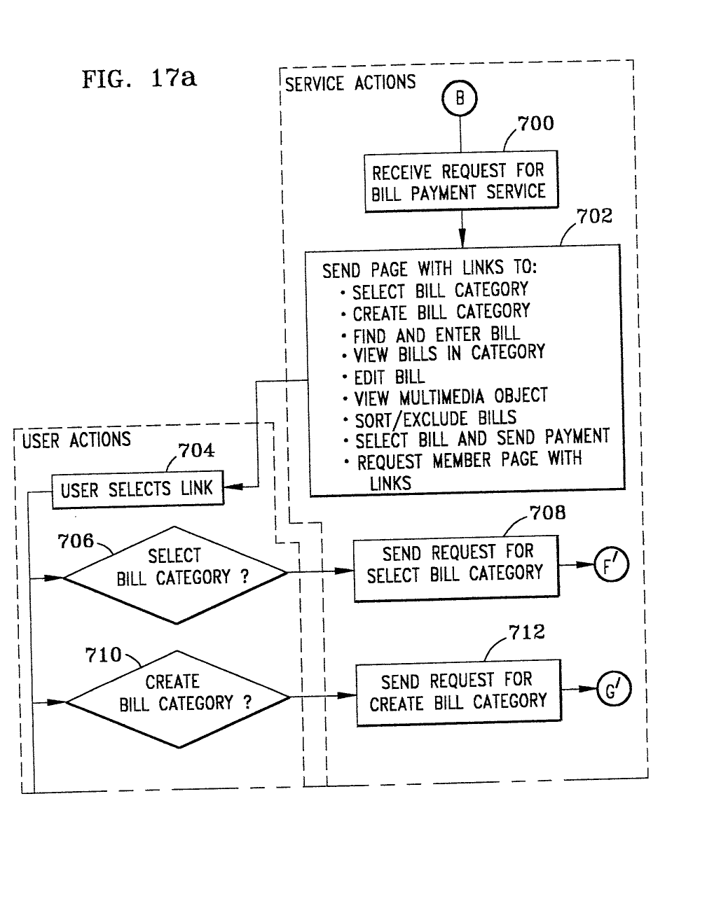

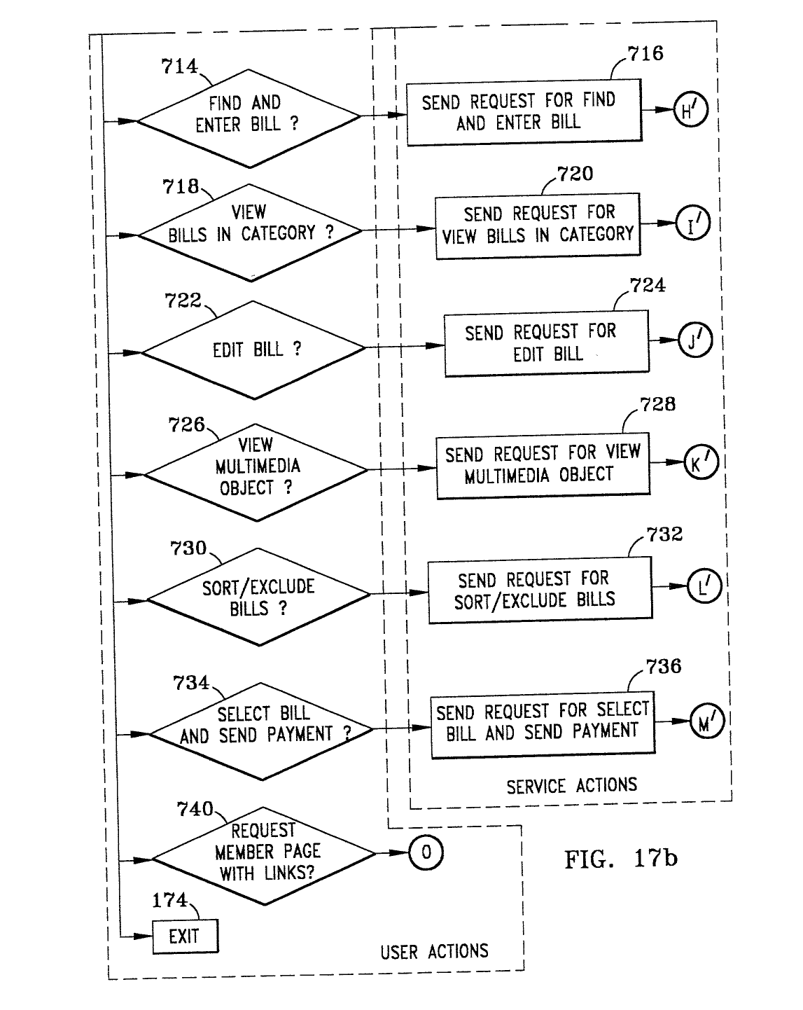

Transaction service system 20 greatly facilitates e-commerce between a user and multiple merchant sites 24 for products and services, as described above. Referring to FIGS. 1-5, 17a and 17b, bill payment module 110 (FIG. 3) of application program 50 of system 20 similarly facilitates receipt, payment, organization and other handling of bills of any type, i.e., not just bills for products purchased in e-commerce from a merchant site 24.

Described very generally, bill payment module 110 permits a user via user computer 28 to access his or her billing records from a billing site 25 (FIG. 1), e.g., a utility or a credit card company, and then create a bill file (not shown) in the same manner e-catalog 124 is created. In addition, bills to multiple billing sites 25 may be paid as a single operation through the use of a payment form 128 (FIG. 3), much like order list 126 may be used to order items from multiple merchant sites 24 as a single operation.

Describing bill payment module 110 in more detail, if at the user selects link step 148 in FIG. 4, the user selects bill payment service link 154, a request is sent at step 156 by user computer 28 to system 20 for the bill payment service, as described above. Following receipt of this request at step 700, system 20 sends a page to user computer 28 at step 702 having links to select bill category, create bill category, find and enter bill, view bills in category, edit bill, view multimedia object, sort/exclude bills, select bill and send payment and request member page with links. User computer 28 receives and displays the page created at step 702, and then at step 704 the user selects one of the links provided at step 702. Because the functionality provided by bill payment module 110 is very similar to that of shopping service module 102, a detailed description of the operation of bill payment module 110 is omitted to avoid redundancy. In this regard it is to be appreciated bill payment module 110 includes submodules analogous to item template module 104, e-catalog module 106 and order form module 108, i.e., a bill template module, a bill file module and a bill payment module, respectively, even though specific reference to such submodules is not provided below. That said, bill module 110 is described in sufficient detail below to provide an understanding of the structure and functionality of the module.

If at step 704 the user chooses select bill category link 706, then at step 708 a request for the same is sent to system 20 as indicated by operation F′. As items may be organized in item categories, so may bills be organized in bill categories. These bill categories may include, for example, utilities, credit cards, car payments and landscaping services. Each bill category has an associated bill template (not shown), analogous to item template 122, in which fields pertinent to a given category of bill are provided, e.g., name and URL of billing entity, new purchases, balance, billing period. Bill files (not shown), analogous to e-catalog 124, are generated for each bill category. If desired, bills may be categorized in a generic bill category which provides less organizational capability, but may be preferred by some users. Payment forms 128 (FIG. 3) are provided for listing the bills to be paid, which are analogous order lists 126 for ordering items.

The steps implemented by bill payment module 110 in operation F′ and user computer 28 are analogous to those implemented by shopping service module 102 in operation F and the user computer, as described above and illustrated in FIG. 6, subject to the differences described above. Thus at the end of operation F′, a bill template for the selected bill category is displayed in frame 54 and information for several bills in the selected bill file is displayed in frame 56.

If at step 704 the user selects create bill category link 710, then at step 712 a request for same is sent to system 20, as indicated by operation G′. Just as shopping service module 102 permits a user to create new item categories, so does bill payment module 110 permit a user to create new bill categories. As a result, the steps implemented by system 20 in operation G′ and user computer 28 are analogous to those implemented by system 20 in operation G and the user computer, as described above and illustrated in FIG. 7. Thus at the end of operation G′ a template is created for the new bill category.

If at step 704 the user selects find and enter bill link 714, then a request for same is sent to system 20, as indicated by operation H′. Bill payment module 110 permits a user to access billing sites 25 and then enter billing information into billing files via a bill template much like item information is entered into e-catalog 24 via an item template 122 from a merchant site 24. Access to such billing information typically requires entry of usemame and password information at billing site 25, since the billing information sought is both personal to the user and private. Billing information from a billing site 25 is displayed in frame 56 of user computer 28. In some cases it may be desirable to implement system 20 so as to permit billing sites 25 to send bills as e-mail notes to system 20, which in turn provides the bills to e-mail reader 132 for the appropriate user computer 28. Ideally, billing sites 25 will provide bills in the form of a bill template of the type provided by system 20. While specific to billing information, the steps performed by system 20 in operation H′ and user computer 28 are analogous to those implemented by system 20 in operation H and the user computer, as described above and illustrated in FIGS. 8 and 9. Thus, at the end of operation H′ the user has entered billing information from one or more billing sites 25 into a billing file in the selected bill category (including a generic category, if desired). This ability to collect in a single bill file billing information from multiple billing sites 25 is an important feature of bill payment module 110.

If at step 704 the user selects the view bill in category link 718, then at step 270, a request for same is sent to system 20 as indicated by operation I′. This link permits a user to access and view a specific bill just as find existing item link 218 permits a user to access and view a specific item. However, the search parameters provided by bill payment module 110 for accessing a bill may differ somewhat from those provided by shopping service module 102 for accessing an item as the parameters are specific for bills. Also bill templates and bill files are provided in operation I′ rather than item templates 122 and e-catalogs 124. In other respects the steps performed in operation I′ by system 20 and user computer 28 are analogous to those performed in operation I by system 20 and the user computer, as described above and illustrated in FIG. 10.

Should the user select edit bill link 722 at step 704, then at step 724, a request for same is sent to system 20 as indicated by operation J′. As with the analogous link 222, edit bill link 722 permits a user to edit a bill, for example to indicate the amount to be paid when less than the total amount due. Following selection of a desired bill category, system 20 sends user computer 28 the bill template and bill file for the bill category selected by the user. Operation J′ ends with system 20 storing the edited bill. Thus with these exceptions, the steps performed in operation J′ by system 20 and user computer 28 are analogous to those performed in operation J by system 20 and the user computer, as described above and illustrated in FIG. 11.

If at step 704 the user requests view multimedia object link 726, then at step 728 a request for same is sent to system 20 as indicated by operation K′. While multimedia objects are less frequently associated with billing information than with products and services, under certain circumstances multimedia objects may be provided, e.g., advertisements or special promotions that relate to the business of the billing site 25. Operation K′ results in the multimedia object being displayed in frame 58 of user computer 28. The steps performed in operation K′ by system 20 and user computer 28 are analogous to those performed in operation K by system 20 and the user computer, as described above and illustrated in FIG. 12.

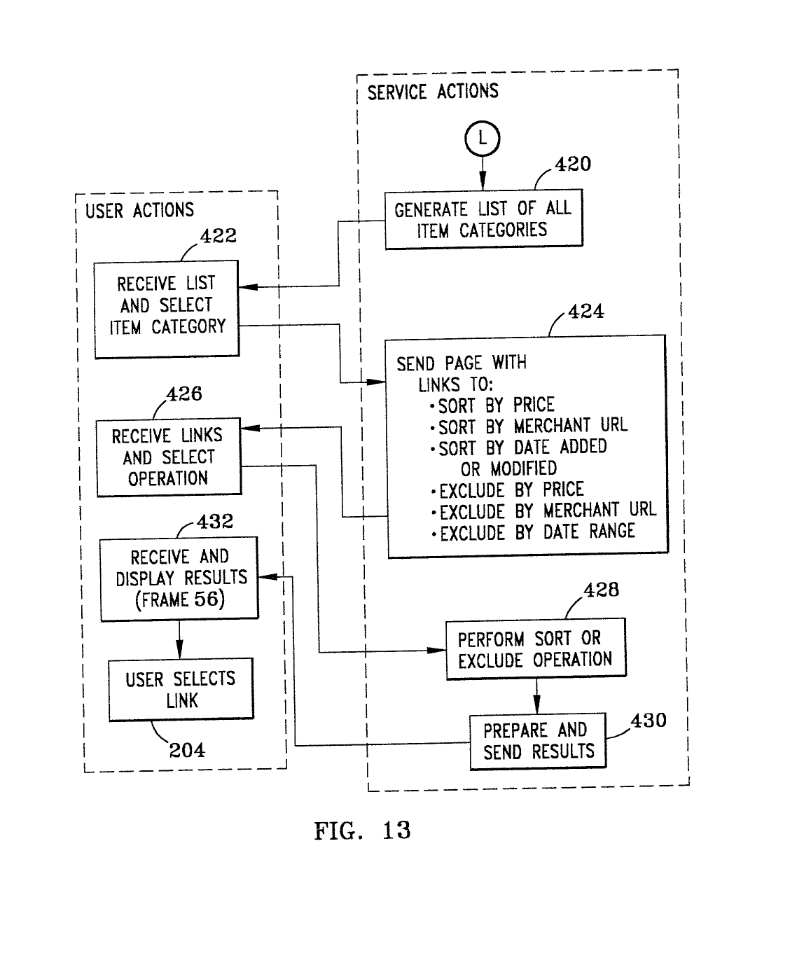

In the event the user chooses at step 704 the sort/exclude bills link 730, then at step 732 a request for same is sent to system 20 as indicated by operation L′. In connection with bill payment, budget reconciliation and other operations users may desire to identify and aggregate bills meeting certain criteria. A series of sort and exclude operations are provided when sort/exclude bill link 730 is selected, much as links to sort and exclude operations are provided at step 424 following selection of sort/exclude item link 230 in shopping service module 102, as described above and illustrated in FIG. 13. However, the sort/exclude operations provided by bill payment module 110 differ from those provided by shopping service module 102 in that they are specific to bill paying. In this regard the sort operations provided by bill payment module 110 include sort by balance amount, sort by URL of the payment site 25 and sort by date the bill was added or modified. The exclude operations include exclude by balance amount, exclude by URL of the payment site 25, and exclude by date range. Other sort and exclude operations may be provided as desired. Operation L′ ends with user computer 28 receiving and displaying in frame 54 bills corresponding to the results of the sort and/or exclude operations. Except as described above, the steps performed in operation L′ by system 20 and user computer 28 are very analogous to those performed in operation L by system 20 and the user computer, as described above and illustrated in FIG. 13.

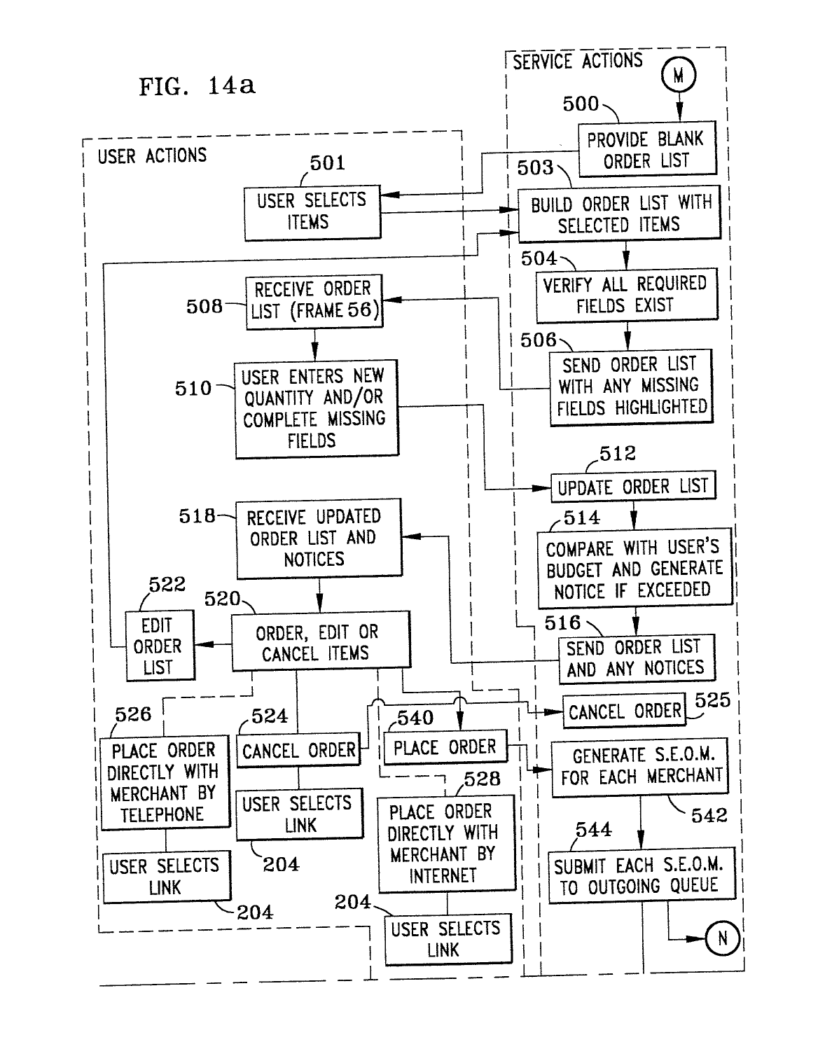

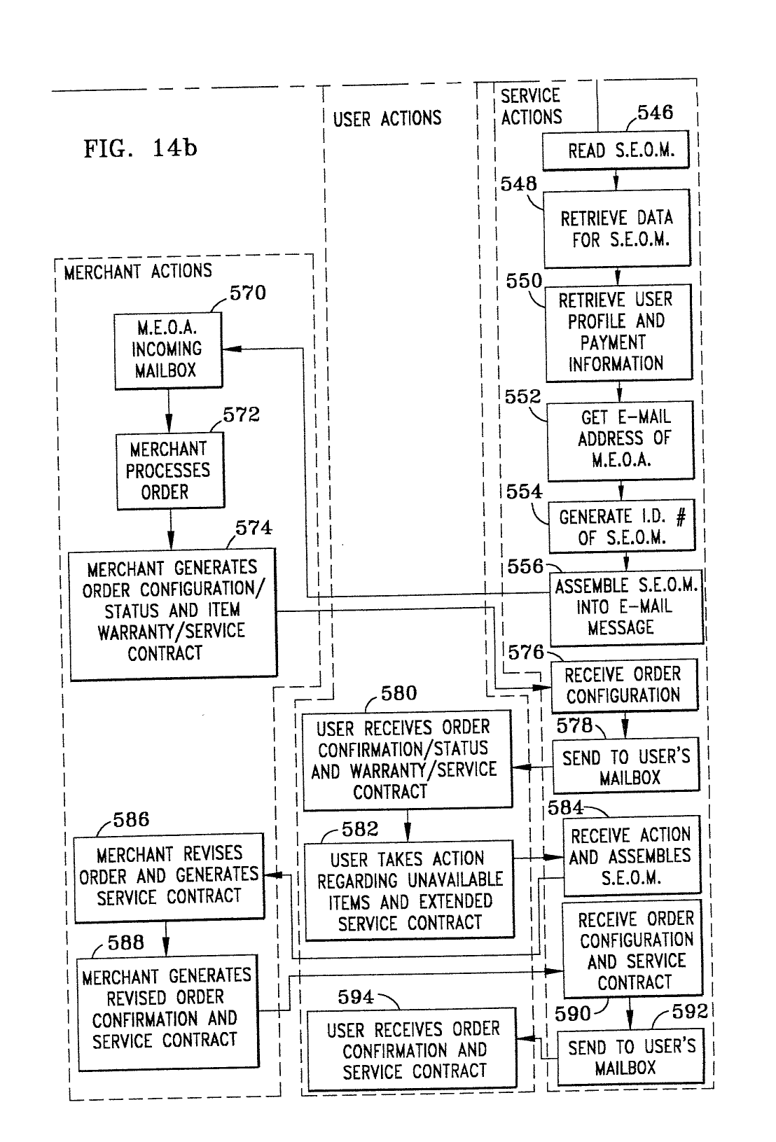

Finally, if at step 704 the user chooses select bills and send payment link 734, then at step 736 a request for same is sent to system 20 as indicated by operation M′. The latter involves creating a payment form 128 which contains bills to be paid, much like order list 126 containing items to be ordered is created, as described above and illustrated in FIGS. 14a and 14b. However, one important difference exists. Frequently, items ordered from a merchant site 24 cannot be shipped at the time ordered. Steps 574-586, in part, address this fact, as described above and illustrated in FIG. 14b. No analogous situation exists with payment of bills. Therefore, operation M′ differs from operation M in this regard and in that the operation pertains to generation and submission of a payment form 128 containing bills to be paid rather than generation and submission of an order list 126 containing items to be purchased. Thus, the SEOM will contain information pertinent to bill payment including the bills to be paid and account information with respect to the bank account or other payment source to be used in paying bills. Also, like an SEOM containing items to be ordered from multiple merchant sites 24 as a single operation, the SEOM generated in operation M′ allows bill payment to may made to multiple billing sites 25 as a single operation. Of course if a central bill paying entity is used, then a single SEOM containing bill payment information for all billing sites 25 may be provided to the single billing entity. If desired, bill payment module may be designed to allow a user to specify on payment form 128 when bills are to be paid. Thus, while the user may submit payment form 128 as a single operation, bill payment module 110 will only authorize release of payment funds at the date specified in payment form 128. This allows bills to be paid at one time, but avoids distribution of funds until payment is actually required. Except as described above, the steps performed in operation M′ by system 20 and user computer 28 are analogous to those performed in operation M by system 20 and the user computer, as described above and illustrated in FIGS. 14a and 14b.

If the user elects not to select any links at step 704, then step 740 allows a user to request the member page with links provided at step 146. Alternatively, at step 174 the user can exit system 20.

E. Investment Portfolio Module

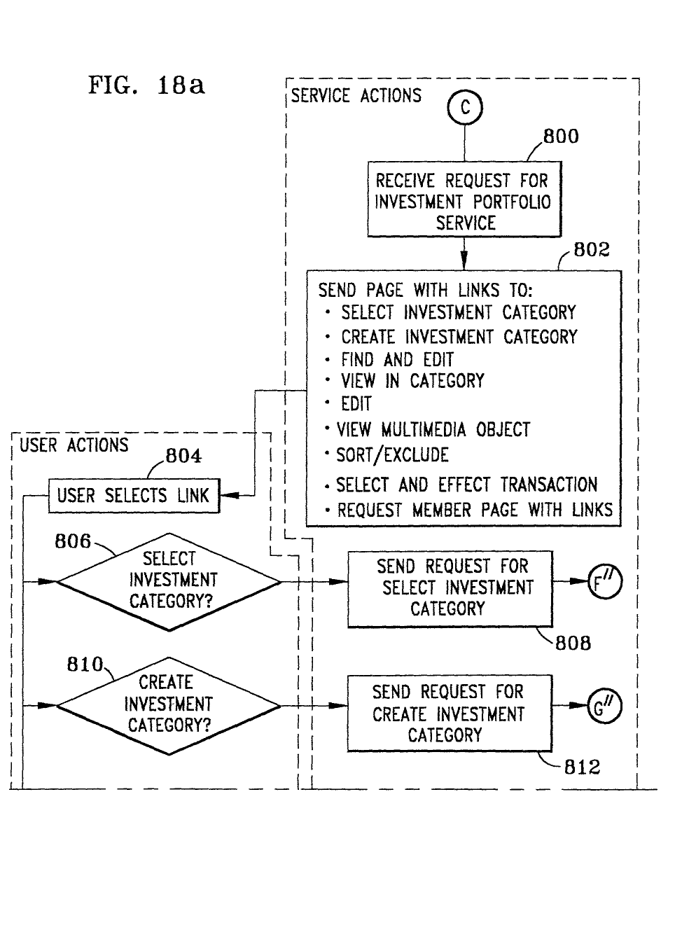

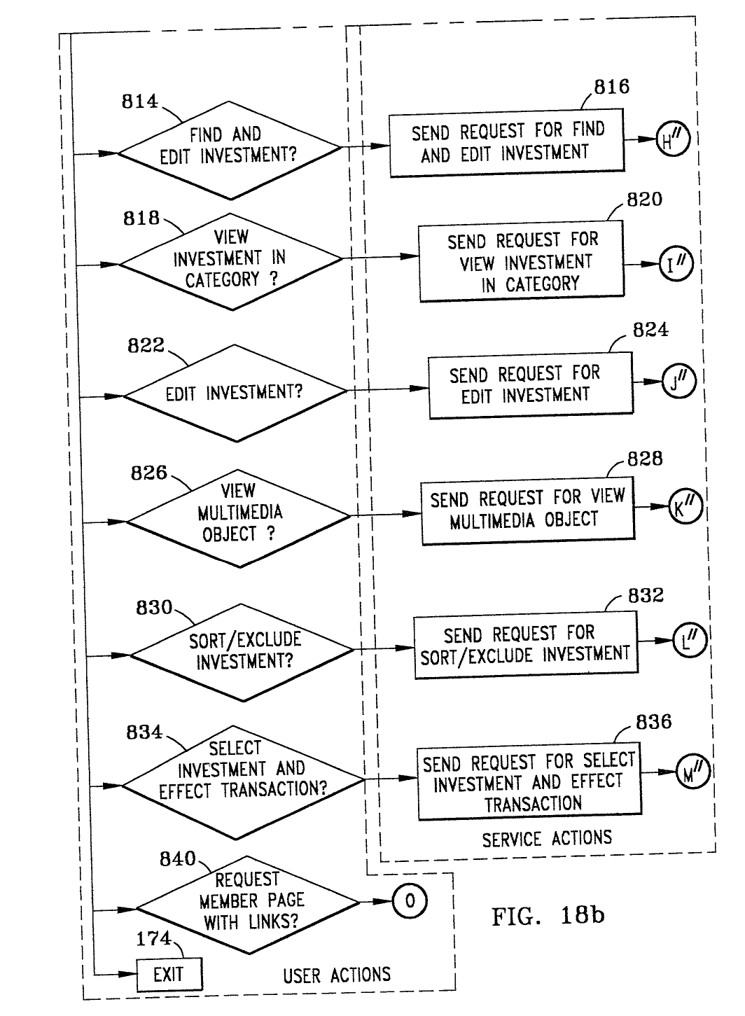

In addition to facilitating e-commerce between a user and multiple merchant sites 24 for products and services, and facilitating bill payment and related functions between a user and multiple billing sites 25, as described above, transaction service system 20 is designed to facilitate investment portfolio activities. Referring to FIGS. 1-5, 18a and 18b, described very generally, investment portfolio module 112 (FIG. 3) of application program 50 of system 20 aids a user in the selection, analysis, purchase, sale, organization and other functions with respect to the contents of an investment portfolio such as stocks, bonds, options, commodities and the like. Thus, investment portfolio module 112 permits a user via user computer 28 to access his or her investment account from an investment site 26 (FIG. 1), e.g., a stock brokerage, and then create a investment portfolio in the same manner e-catalog 124 is created. Research regarding a company in which an investment is contemplated or exists may also be conducted by contacting Internet sites or other on-line sources of information in network 22 via user computer 28, and then recording the results in a research file in the same manner e-catalog 124 is created. In addition, although perhaps less significant than with respect to the shopping bill payment services described above, investments may be purchased from multiple investment sites 26 as a single operation through the use of a transaction form 130 (FIG. 3), much like order list 126 may be used to order items from multiple merchant sites 24 as a single operation. This is desirable where, for example, a user works with one investment site 26 for 401(K) investments, another site that has expertise with emerging growth stocks, and a third site that has expertise with commodities.

Describing investment module 112 in more detail, if at the user selects link step 148 in FIG. 4, the user selects investment portfolio service link 158, a request is sent at step 160 by user computer 28 to system 20 for the investment portfolio service, as described above. Following receipt of this request at step 800, system 20 sends a page to user computer 28 at step 802 having links to select investment category, create investment category, find and enter investment, view investments in category, edit investment, view multimedia object, sort/exclude investments and select investment and effect transaction, and request member page with links. User computer 28 receives and displays the page created at step 802, and then at step 804 the user selects one of the links provided at step 802. Because the functionality provided by investment portfolio module 112 is very similar to that of shopping service module 102, a detailed description of the operation of investment portfolio module 110 is omitted to avoid redundancy. In this regard it is to be appreciated investment portfolio module 112 includes submodules analogous to item template module 104, e-catalog module 106 and order form module 108, i.e., an investment template module, an investment account module and an investment transaction module, respectively, even though specific reference to such submodules is not provided below. That said, investment portfolio module 112 is described in sufficient detail below to provide an understanding of the structure and functionality of the module.

If at step 804 the user chooses select investment category link 806, then at step 808 a request for the same is sent to system 20 as indicated by operation F″. As items may be organized in item categories, so may investments be organized in investment categories. These investment categories may include, for example, stocks, bonds, options and commodities. Alternatively, all investments with one stockbroker may be maintained in one investment category, all investments with a second stockbroker may be maintained in a second category, and so on. As yet another alternative, investment categories may be created for companies being analyzed for investment purposes, with one category being used for each company. In some cases, an investment category may be created for a group of companies meeting certain criteria. In these latter cases, the term “investment” is used somewhat loosely as it pertains to investment category, insofar as certain of the categories may not relate to specific investments, but rather to research pertaining to a potential or actual investment.

Each investment category, e.g., stocks, treasury bills and junk bonds, has an associated investment template, analogous to item template 122, in which fields pertinent to a given category of investment are provided, e.g., name and URL of investment entity, name and quantity of investment, and purchase price. When tracking information about companies for investment purposes, fields in the investment template might include products, annual sales, profit margins, market share and stock price. A number of predefined investment templates for common investment types are typically provided by investment portfolio module 112. Investment accounts, analogous to e-catalogs 124, are generated for each investment category. Here too, the term “investment” as used with respect to investment accounts is not limited to merely investments such as stocks and bonds. Company research for a given company, for example, may be included in an investment account. If desired, investments may be categorized in a generic investment category which provides less organizational capability, but may be preferred by some users. Transaction forms 130 are provided for listing the investments to be purchased, which are analogous order lists 126 for ordering items.

The steps implemented by investment portfolio module 112 in operation F′ and user computer 28 are analogous to those implemented by shopping service module 102 in operation F and the user computer, as described above and illustrated in FIG. 6, subject to the differences described above. Thus at the end of operation F″, an investment template for the selected investment category is displayed in frame 54 and information for several investments in the selected investment account is displayed in frame 56.

If at step 804 the user selects create investment category link 810, then at step 812 a request for same is sent to system 20, as indicated by operation G″. Just as shopping service module 102 permits a user to create new item categories, so does investment portfolio module 112 permit a user to create new investment categories. This flexibility in investment portfolio creation is important as very different templates are needed, for example, for stock a user owns, company research and market sector analyses. Except that the steps following selection of link 810 pertain to investments rather than items, the steps implemented by system 20 in operation G″ and user computer 28 are analogous to those implemented by system 20 in operation G and the user computer, as described above and illustrated in FIG. 7. Thus at the end of operation G″ a template is created for the new investment category.

In the event at step 804 the user selects find and enter new item link 814, then at step 816 a request for same is sent to system 20, as indicated by operation H″. Investment portfolio module 112 permits a user to access investment sites 26 and then enter investment information into investment accounts via an investment template much like item information is entered into item template 122 from a merchant site 24. Access to such investment information typically requires entry of username and password information at investment site 26, since the investment information sought is both personal to the user and private. Alternatively, a user may select and enter information from other Internet sites. For example, when researching a company for the purpose of a possible investment, information may be selected and entered following selection of link 814 by accessing the company's web site, the web sites of market research firms having information about the company, the web sites of newspapers and magazines and other Internet sources. Investment information from an investment site 26 or other web site is displayed in frame 56 of user computer 28. While specific to investment information, the steps performed by system 20 in operation H″ and user computer 28 are analogous to those implemented by system 20 in operation H and the user computer, as described above and illustrated in FIGS. 8 and 9. Thus at the end. of operation H″ the user has entered investment information from one or more investment sites 26, and/or from one or more other web sites, into an investment account in the selected investment category. This ability to collect in a single investment account information from multiple investment sites 26 is an important feature of investment portfolio module 112.

If at step 804 the user selects the view investments in category link 818, then at step 820 a request for same is sent to system 20 as indicated by operation I″. This link permits a user to access and view a specific bill just as find existing item link 218 permits a user to access and view a specific item. However, the search parameters provided by investment portfolio module 112 for accessing a bill may differ somewhat from those provided by shopping service module 102 for accessing an item as the parameters are specific for investments. Also investment templates and investment accounts are provided in operation I″ rather than item templates 122 and e-catalogs 124. In other respects the steps performed in operation I″ by system 20 and user computer 28 are analogous to those performed in operation I by system 20 and the user computer, as described above and illustrated in FIG. 10.

Should the user select edit investment link 822 at step 804, then a request for same is sent to system 20 as indicated by operation J″. As with the analogous link 222, this link permits a user to edit an investment, for example to indicate a change in asset allocation or share price. Or when tracking company information, edit investment link 822 permits a user to modify previously entered data such as quarterly sales, new product offerings and the like. Following selection of a desired investment category, system 20 sends user computer 28 the investment template and investment account for the investment category selected by the user. Operation J″ ends with system 20 storing the edited investment. Thus, with these exceptions, the steps performed in operation J″ by system 20 and user computer 28 are analogous to those performed in operation J by system 20 and the user computer, as described above and illustrated in FIG. 11.

If at step 804 the user requests view multimedia object link 826, then a request for same is sent to system 20 as indicated by operation K″. While multimedia objects are less frequently associated with investments than with products and services, under certain circumstances multimedia objects may be provided, e.g., company statements, interviews, press releases and investor presentations. Operation K″ results in the multimedia object being displayed in frame 58 of user computer 28. The steps performed in operation K″ by system 20 and user computer 28 are very analogous to those performed in operation K by system 20 and the user computer, as described above and illustrated in FIG. 12.

In the event the user chooses at step 804 the sort/exclude investments link 830, then at step 832 a request for same is sent to system 20 as indicated by operation L″. In connection with investment analysis and research users may desire to identify and aggregate investments and related information meeting certain criteria. A series of sort and exclude operations are provided when sort/exclude investment link 830 is selected, much as links to sort and exclude operations are provided at step 424 following selection of sort/exclude item link 230 in shopping service module 102, as described above and illustrated in FIG. 13. However, the sort/exclude operations provided by investment portfolio module 112 differ from those provided by shopping service module 102 in that they are specific to investments and related analysis and research. In this regard the sort operations provided by investment portfolio module 112 include sort by URL of the investment site 26 and sort by date the investment was added or modified. The exclude operations include exclude by URL of the investment site 26, and exclude by date range. Other sort and exclude operations may also be provided, as described. Operation L″ ends with user computer 28 receiving and displaying in frame 54 investments or related information, e.g., company research, corresponding to the results of the sort and/or exclude operations. Except as described above, the steps performed in operation L″ by system 20 and user computer 28 are very analogous to those performed in operation L by system 20 and the user computer, as described above and illustrated in FIG. 13.

Finally, if at step 804 the user chooses select investment and effect transaction link 834, then at step 836 a request for same is sent to system 20 as indicated by operation M″. Creating a transaction form 130 which contains investments to be bought or sold is much like creating an order list 126 containing items to be ordered, as described above and illustrated in FIGS. 14a and 14b. Several differences do, however, exist. First, when a user submits a request to purchase or sell an investment, a unit price, e.g., dollars per share of stock, investment name and type and other information is typically required. Thus, operation M″ contains steps analogous to steps 504 and 506 to uncover and identify to the user whether all required information is provided.

Second, when an investment cannot be purchased or sold at the target price provided in transaction form 130, in steps analogous to steps 572 and 574 (FIG. 14b) investment site 26 determines whether the investment can be purchased or sold at the target price and in the target quantities. If it can, then investment site 26 sends an order confirmation indicating the date, quantity, price and other pertinent factors of the transaction, which is received by system 20 at a step analogous to step 576. If the investment cannot be purchased or sold at the target price and/or quantities, then investment site 26 sends a message advising such is the case. This message preferably includes a form requesting direction whether the transaction should be completed at another price and/or quantity target, or whether it should be canceled. Following action by the user with respect to the inquiry in the form, in a step analogous to step 582, investment site 26 processes the revised request, if possible at the new price and/or quantity targets specified, and then sends an order confirmation to the user, in steps analogous to steps 586 and 588. If the investment cannot be purchased or sold at the new price and/or quantity targets specified by the user, then another message and form requesting direction is provided by investment site 26.

Like shopping service module 102, investment portfolio module 112 generates an SEOM containing information pertinent to the purchase or sale of investments and account information with respect to the bank account or other payment source to be used in purchasing the investment. Also, like an SEOM containing items to be ordered from multiple merchant sites 24 as a single operation, the SEOM generated in operation M″ allows investments to be purchased or sold through multiple investment sites 26 as a single operation. Thus, except as described above, the steps performed in operation M″ by system 20 and user computer 28 are very analogous to those performed in operation M by system 20 and the user computer, as described above and illustrated in FIGS. 14a and 14b.

If the user elects not to select any links at step 804, then at step 840 the user may request the member page with links provided at step 146. Alternatively, at step 174 the user can exit system 20.

F. E-Mail Module

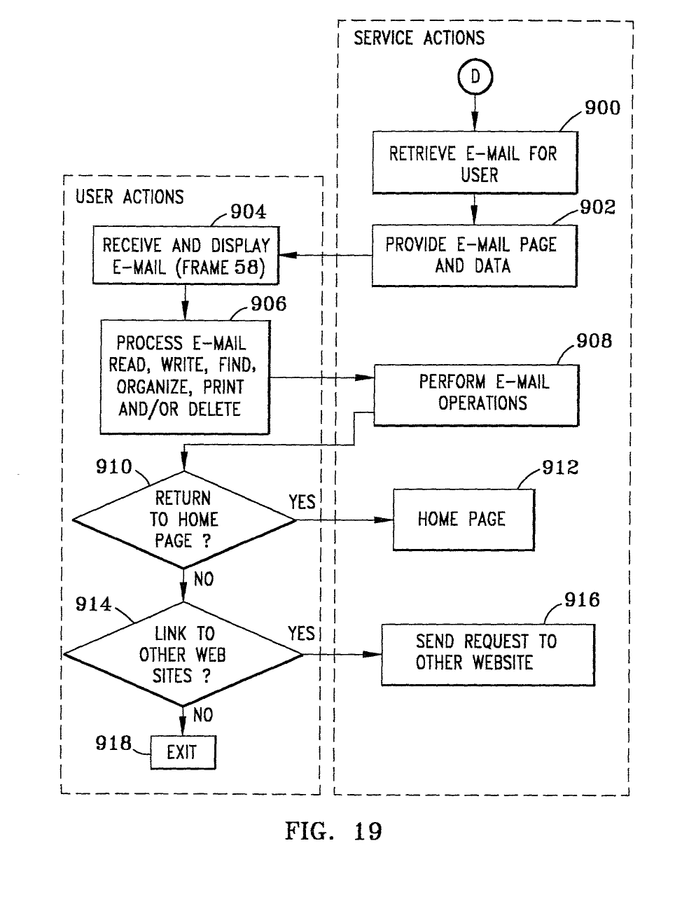

Referring to FIGS. 1-4 and 19, if a user desires to send or retrieve e-mail, the user selects link step 148 (FIG. 4) and then the user chooses e-mail reader link 162, thereby causing user computer 28 at step 164 to send a request for e-mail reader 132 to system 20. Following receipt of this request, at step 900 system 20 retrieves e-mail for the user, and then at step 902 provides e-mail reader 132 that permits a user to read, write, find, organize, print and/or delete e-mail. In addition, unread and stored e-mail retrieved at step 900 is included in e-mail reader 132 and sent to user computer 28. At step 904 user computer 28 receives and displays e-mail reader 132, typically in frame 58, although if desired the e-mail reader may occupy the entire display 52 of the user computer. Next, at step 906, a user performs conventional e-mail processes, i.e., reads, writes, finds, organizes, deletes and/or prints e-mail using functionality (not shown) provided on e-mail reader 132, and sends the results of this processing to user computer 28. Then, at step 908, user computer 28 performs the e-mail operations requested at step 906 and sends the results to user computer 28 along with two inquiries (steps 910 and 914) regarding further action to be taken by the user. Then, at step 910, the user is provided with the option to return to the home page for system 20. If the user elects this option, then, as noted by step 912, the user returns to the home page. If the user elects not to return to the home page, then the user is given another option at step 914 to link to other web sites. If the user chooses this option and specifies the web site to which a link is requested, then at step 916 user computer 28 through its browser 26 attempts to effect this link. Alternatively, at step 918, the user may choose to exit the e-mail service, thereby returning the user to the member page at step 146.

If desired, system 20 may be implemented so that notices appear when the user first logs on to system 20 at the member page. These notices may include, for example, an indication new mail has been received (e.g., an order confirmation), special offers, new product listings, new bills, and investment opportunities. Thus, rather than requiring a user to select e-mail reader link 162 to obtain certain information concerning e-mail, it may be provided at the time of log in.

G. Change Profile/Settings Module

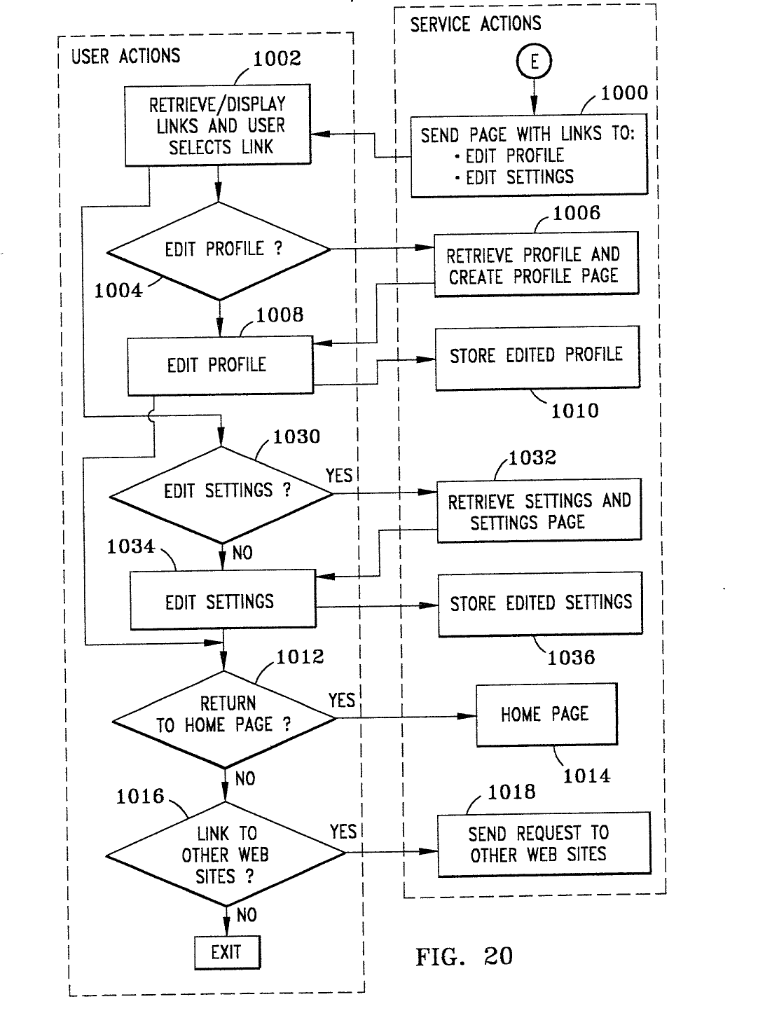

Turning now to FIGS. 1-4 and 20, transaction service system 20 provides the user with the opportunity to edit his or her profile, for example to input a change of address, as well as to modify various settings, e.g., the relative size and placement of frames 54, 56 and 58. If at step 148 (FIG. 4) the user selects link 166 to change profile/settings, then at step 168 user computer 28 sends such a request to system 20. Upon receipt of this request, at step 1000, system 20 sends a page with links to edit profile and edit settings. At step 1002, user computer 28 receives and displays the link page and then the user selects one of the two links provided. If the user selects edit profile link 1004, then user computer 28 sends this request to system 20 where, at step 1006, the system retrieves the user profile and creates a profile page. This page is then sent to user computer 28 and at step 1008 the user edits his or her profile and sends it to system 20 where at step 1010 it is stored. After edit profile step 1008, the user is provided with link 1012 where he or she is given the opportunity to return to the home page. If the user so desires, then at step 1014 the user returns to the home page. If the user indicates he or she does not want to return to the home page, then at link 1016 the user is given the opportunity to link to other web sites. If the user requests such a link, after providing the appropriate URL user computer 28 sends a request at step 1018 to the other web sites in an attempt to affect the link. If at step 1016 the user indicates link to other web sites is not desired, then at step 1020 an exit from the edit profile/settings services provided and the user is returned to user select link 148.

If the user at step 1002 selects edit settings link 1030, then user computer sends this request to system 20 where, at step 1032, the system retrieves existing settings and generates and sends a change settings page to user computer 28. Following receipt of this settings page and modifications of the existing settings at step 1034, user computer 28 sends the edited settings to system 20, where, at step 1036 they are stored. After the user submits the edited settings at step 1034, the user is returned to link 1012, as discussed above. Transaction service system 20 has been described above as a vehicle for facilitating transactions between a user computer 28 and one or more of a merchant site 24, a bill payment site 25 and an investment site 26. However, it is to be appreciated that system 20 is not constrained to operate only in such environments. In fact system 20 is extremely flexible in its application and may be used in virtually any environment for virtually any purpose. In its broadest implementation, system 20 has a template module (not shown) that provides a template (not shown) viewable on display 52 of user computer 28 that may be used to enter almost any type of information available from any site in network 22 with which the user computer is connected. In other words, the template module need not be, for example, an item template 122 that is specific to items. A folder module is also provided that permits a user to assemble a folder containing information regarding items offered at one or more site on network 22. Thus, e-catalog 24 is only one implementation of the more generic folder module encompassed by the present invention. Also, system 20 may be used with sites where the items offered are information, and the information may be offered in the sense that it is made available, rather than sold or licensed.

Even in this broad implementation of system 20, the template and information in the folder are provided for viewing in display 52 of user computer 28 so that they do not occupy the entire display. This permits the user to display content from a site on network 22 in portions of display 52 not occupied by the template and information from the folder.

Since certain changes may be made in the above system without departing from the scope of the invention herein involved, it is intended that all matter contained in the above description as shown in the accompanying drawings shall be interpreted in an illustrative and not in a limiting sense.

What is claimed is:

1. A transaction service system in a service computer for supporting e-commerce across a distributed computer network including a user computer having a display and browser for navigating the network, and a plurality of merchant sites each having a unique URL and an e-commerce system for enabling sale or other transfer of items, which e-commerce system may be accessed via the network with the browser of the user computer, the transaction service system comprising:
a. an item template module that provides an item template, permits a user to enter in said item template information available at a merchant site regarding an item offered by the merchant site, and provides for viewing on a first portion of the display of the user's computer at least one of said item templates;
b. an e-catalog module that permits a user to assemble an e-catalog containing information regarding items offered at more than one merchant site, and provides for viewing on a second portion of the display of the user's computer at least some of said information in said e-catalog; and
c. wherein said first portion and said second portion are sized so that a third portion of the display of the user's computer is not occupied by said first portion and said second portion.

2. A system according to claim 1, further including an order module that permits a user to assemble, and submit as a single operation, an order containing items in said e-catalog from more than one merchant site.

3. A system according to claim 2, wherein said order module delivers to each merchant site offering items included in said order a communication identifying those items in said order provided by said merchant site.

4. A system according to claim 3, wherein said communication includes address information and payment information with respect to the user.

5. A system according to claim 1, wherein information entered in an item template is entered by said item template module in said e-catalog.

6. A system according to claim 1, wherein said item template module permits a user to classify items by category.

7. A system according to claim 1, wherein said e-catalog module creates e-catalogs including only items in a given category.

8. A system according to claim 1, wherein said item template includes fields in which information regarding an item may be entered.

9. A system according to claim 1, wherein said information entered in said item templates and contained in said e-catalogs is stored in the service computer.

10. A system according to claim 1, wherein said item template module permits multimedia objects that are associated with said items to be entered in said item templates.

11. A system according to claim 10, wherein said item template module provides for viewing in the display of the user's computer a plurality of thumbnail objects, each associated with one of said items.

12. A system according to claim 2, wherein said order module permits a user to establish a budget amount for items to be obtained via said plurality of merchant computers, and compares the price of items included in an order with said budget amount to determine if said price exceeds said budget amount.

13. A system according to claim 1, further including a bill payment module for facilitating the payment of bills.

14. A system according to claim 13, wherein said bill payment module comprises:
a. a bill template module that provides templates in which a user may enter billing information available at a plurality of billing sites, and provides for viewing on said first portion of the display of the user's computer at least one of said bill templates; and
b. a bill file module that permits a user to assemble a bill file containing information regarding bills from one or more of the plurality of billing sites, and provides for viewing on said second portion of the display of the user's computer at least some of the information contained in the bill file.

15. A system according to claim 13, wherein said bill payment module permits a user to assemble, and submit as a single operation, a payment for bills to more than one billing site.

16. A system according to claim 1, further including an investment portfolio module for facilitating investment activity.

17. A system according to claim 16, wherein investment portfolio module comprises:
a. an investment portfolio module that provides investment templates in which a user may enter investment information available at a plurality of investment sites, and provides for viewing on said first portion of the display of the user's computer at least one of said investment templates; and
b. an investment account module that permits a user to assemble an investment account containing information regarding investments from one or more of the plurality of investment sites, and provides for viewing on said second portion of the display of the user's computer at least some of the information contained in the investment account.

18. A system according to claim 16, wherein said investment portfolio module permits a user to assemble, and submit as a single operation, a request to buy or sell investments to more than one investment site.

19. An e-commerce system, comprising:
a. a computer network;
b. at least one user computer connectable with said network, said at least one user computer having a display and a browser for navigating said network;
c. a plurality of merchant computers connectable with said at least one user computer via said network, each merchant computer being programmed to operate an e-commerce system for enabling e-commerce with said at least one user computer;
d. a service computer connectable with said at least one user computer and said plurality of merchant computers via said network; and
e. said service computer being programmed to operate a shopping system that permits a user to order items in a single order from more than one of said merchant computers.

20. A system according to claim 19, wherein said shopping system permits a user to store information regarding items offered by one or more of said plurality of merchant computers, and provides at least some of said information so that it may be displayed in only one portion of said display of said user computer so that the user may display content from one or more of said plurality of said merchant computers in other than said one portion of said display.

21. A system according to claim 19, wherein said shopping system permits a user to store information by category.

22. A method of assisting a user having a user computer with a display and a browser in obtaining items offered at a plurality of merchant sites linked via a network that the user can navigate with the browser so as to access merchant sites, the method comprising the steps of:
a. providing a template to the user computer, via the network, in which a user may enter information regarding an item offered at a merchant site, wherein said template is provided so that it may be viewed on the display of the user computer at the same time content from the merchant site may be viewed in the display of the user computer;
b. building a collection of said information regarding items offered at more than one merchant site and providing at least some of said information in said collection so that it may be viewed on the display of the user computer at the same time content from the merchant site may be viewed in the display of the user computer; and
c. creating an order using said information in said collection for items from more than one merchant site and transmitting a request to each merchant site for those items included in said order which said each merchant site offers.

23. A method according to claim 22, wherein said step a and said step b are performed so that a third portion of said display of said user computer may contain content from a merchant site at the same time at least one of (a) said template and (b) said at least some of said information is displayed in the display of the user computer.

24. A method according to claim 22, further including the step of searching for said information for items of interest to the user based on input provided by the user.

25. A method of obtaining items offered at a plurality of merchant sites linked via a network that the user can navigate with the browser of a user computer so as to access merchant sites, the method comprising the steps of:
a. linking with a merchant site so as to display content from the merchant site in the display of the user computer;
b. entering information regarding items available at the merchant site in an item template viewable in the display of the user computer at the same time said content is displayed; and
c. manipulating information in an e-catalog viewable in the display of the user computer at the same time said content is displayed.

26. An e-commerce system intended to assist a user having a user computer with a display and a browser in obtaining items offered at a plurality of merchant sites linked via a network that the user can navigate with the browser to as to access merchant sites, the system comprising:
a. first means for providing a template to the user computer, via the network, in which a user may enter information regarding an item offered at a merchant site, wherein said template is provided so that it may be viewed on the display of the user computer so that the user may simultaneously view content from the merchant site on the display of the user computer;
b. second means for building a collection of said information regarding items offered at more than one merchant site and providing at least some of said information in said collection so that the user may simultaneously view content from the merchant site on the display of the user computer; and
c. third means for creating an order using said information in said collection for items from more than one merchant site and transmitting a request to each merchant site for those items included in said order which said each merchant site offers.

27. A system according to claim 26, wherein said first means provides said template for display, and said second means provides said at least some information for display, so that a third portion of said display of said user computer may contain content from a merchant site at the same time at least one of (a) said template and (b) said at least some of said information is displayed in the display of the user computer.

28. A computer-readable storage medium containing a computer program executable by a service computer linked to a computer network and designed to assist a user having a user computer with a display and a browser in obtaining items offered at a plurality of merchant sites linked via the computer network that the user can navigate with the browser to as to access merchant sites, the computer program comprising the steps of:
a. providing a template to the user computer, via the network, in which a user may enter information regarding an item offered at a merchant site, wherein said template is provided so that it may be viewed on the display of the user computer at the same time content from the merchant site may be viewed in the display of the user computer;
b. building a collection of said information regarding items offered at more than one merchant site and providing at least some of said information in said collection so that it may be viewed on the display of the user computer at the same time content from the merchant site may be viewed on the display of the user computer; and
c. creating an order using said information in said collection for items from more than one merchant site and transmitting a request to each merchant site for those items included in said order which said each merchant site offers.

29. A computer-readable storage medium according to claim 28, wherein said step a and said step b are performed so that a third portion of said display of said user computer may contain content from a merchant site at the same time at least one of (a) said template and (b) said at least some of said information is provided in the display of the user computer.

30. A transaction service system in a service computer for supporting activities across a distributed computer network including a user computer having a display and browser for navigating the network, and a plurality of sites each having a unique URL and information pertaining to one or more subjects, which information can be accessed via the browser of the user computer, the transaction service system comprising:
a. a template module that provides templates in which a user may enter information available at the plurality of sites, and provides for viewing on a first portion of the display of the user's computer at least one of said templates;
b. a folder module that permits a user to assemble a folder containing information regarding items offered at one or more of the plurality of sites, and provides for viewing on a second portion of the display of the user's computer at least some of the information contained in said folder; and
c. wherein said first portion and said second portion are sized so that a third portion of the display of the user's computer is not occupied by said first portion and said second portion.

31. A system according to claim 30, further including an order module that permits a user to assemble, and submit as a single operation, a request for items in said folder from more than one site.

32. A system according to claim 31, wherein said order module delivers to each site offering items included in said request a communication identifying those items in said request provided by said merchant site.

33. A system according to claim 32, wherein said communication includes user profile and payment information.

34. A system according to claim 30, wherein information entered in a template is entered by said template module in said folder.

35. A system according to claim 30, wherein said template module permits a user to classify items by category.

36. A system according to claim 30, wherein item template module creates folders including only items in a given category.

37. A system according to claim 30, wherein said template includes fields in which information regarding an item may be entered.

38. A system according to claim 30, wherein said information entered in said templates and said folders is stored in the service computer.

39. A system according to claim 30, wherein said system stores said items entered in said templates in said service computer.

40. A system according to claim 30, wherein said information entered in said template may include multimedia objects.

41. A system according to claim 30, wherein said system permits a user to establish a budget amount for items to be obtained via the plurality of sites, and compares the price of items included in a request with said budget amount to determine if said price exceeds said budget amount.

42. A system according to claim 30, wherein (a) said template module provides said at least one of said templates for viewing in said first portion and (b) said folder module provides said at least some of the information contained in said folder for viewing in said second portion so that content from at least one of said plurality of sites may be simultaneously viewed in said third portion of the display of the user's computer.

43. A system according to claim 30, wherein said template is an item template and said folder is an e-catalog.

44. A system according to claim 30, wherein said template is a bill form and said folder is a bill file.

45. A system according to claim 30, wherein said template is a transaction form and said folder is an investment account.

46. A billing service system in a service computer for supporting billing activities across a distributed computer network including a user computer having a display and browser for navigating the network, and a plurality of billing sites each having a unique URL and a billing system for enabling bill payment and other activities, which billing system may be accessed via the network with the browser of the user computer, the billing service system comprising:
a. a bill template module that provides a bill template, permits a user to enter in said bill template information available at a billing site regarding a bill at the billing site, and provides for viewing on a first portion of the display of the user's computer at least one of said bill templates;
b. a bill file module that permits a user to assemble a bill file containing information regarding bills at the billing site, and provides for viewing on a second portion of the display of the user's computer at least some of said information in said bill file; and
c. wherein said first portion and said second portion are sized so that a third portion of the display of the user's computer is not occupied by said first portion and said second portion.

47. A system according to claim 46, further comprising a bill payment module that permits a user to assemble, and submit as a single operation, a payment for bills to more than one billing site.

48. A system according to claim 47, wherein said bill payment module permits a user to specify when payment for each bill is to made to each billing site.

49. A system according to claim 46, wherein said bill template module permits a user to classify bills by category.

50. An investment portfolio system in a service computer for supporting investment activities across a distributed computer network including a user computer having a display and browser for navigating the network, and a plurality of investment sites each having a unique URL and an investment system for enabling investment activities, which investment system may be accessed via the network with the browser of the user computer, the investment portfolio system comprising:
a. an investment template module that provides investment templates in which a user may enter investment information available at a plurality of investment sites, and provides for viewing on a first portion of the display of the user's computer at least one of said investment templates;
b. an investment account module that permits a user to assemble an investment account containing information regarding investments from one or more of the plurality of investment sites, and provides for viewing on a second portion of the display of the user's computer at least some of the information contained in the investment account; and
c. wherein said first portion and said second portion are sized so that a third portion of the display of the user's computer is not occupied by said first portion and said second portion.

51. A system according to claim 50, further comprising an investment transaction module that permits a user to assemble, and submit as a single operation, a request to complete investment transactions to more than one investment site.

52. A system according to claim 51, further wherein said investment transaction module permits a user to specify a target sale or purchase price for an investment.

53. A system according to claim 50, wherein said investment template module permits a user to classify investments by category.
